(19) United States
(12) Patent Application Publication
(10) Pub. No.: US 2016/0104873 A1
(43) Pub. Date: Apr. 14, 2016

(54) BATTERY PACK SYSTEM AND METHOD FOR FABRICATION THEREOF

(71) Applicant: Vecture Inc., Concord (CA)

(72) Inventor: Dave Smythe, Caledon (CA)

(73) Assignee: Vecture Inc., Concord (CA)

(21) Appl. No.: 14/511,380

(22) Filed: Oct. 10, 2014

(51) Int. Cl. H01M 2/10; H01M 2/12; H01M 10/052; H01M 10/42; H01M 2/20; H01M 10/65; H01M 10/48

(52) U.S. Cl. CPC H01M 2/1016; H01M 10/65; H01M 2/1241; H01M 10/486; H01M 10/425; H01M 2/202; H01M 2/204; H01M 2/206; H01M 2/1022; H01M 2/1072; H01M 10/052; H01M 2010/4271

(57) ABSTRACT

Various embodiments of battery pack assemblies are described. In at least one embodiment, a battery pack assembly includes first and second cell carriers. At least one of the carriers is a retaining cell carrier, has a plurality of upstanding walls extending from a bottom wall thereof and defines a matrix of recesses. At least one of the carriers is a perforated cell carrier and has a wall with a plurality of openings. Battery cells, each having a plurality of cell terminals, are retained within the matrix of recesses and at least a subset of the plurality of cell terminals extend through the openings of the wall of the perforated cell carrier. Electrically conductive interconnecting members are electrically coupled to at least two of the cell terminals of the battery cells that extend through the openings of the perforated cell carrier to provide an electrical interconnection therebetween.

### FIELD

Various embodiments are described herein for a battery pack assembly and method for fabrication thereof.

### BACKGROUND

A battery pack system typically comprises one or more battery cells that are encased within a housing of the battery pack system. The battery pack system can provide flexibility in meeting a given set of electrical requirements. However, a battery pack system is typically formed from the assembly of a large number of separate parts, which may increase costs where different designs are required. For example, use of different types of battery cells or a different number of cells may affect the size of the battery pack system to be fabricated. Moreover, some parts may be sensitive to internal forces, such as thermal dissipation, and external forces such as vibration on the pack.

### SUMMARY OF VARIOUS EMBODIMENTS

In one broad aspect, at least one embodiment described herein provides a battery pack assembly comprising a first cell carrier, a second cell carrier, at least one of the first cell carrier and the second cell carrier being a retaining cell carrier and having a plurality of upstanding walls extending from a bottom wall thereof and defining a matrix of recesses and at least one of the first cell carrier and the second cell carrier being a perforated cell carrier and having a wall with a plurality of openings; a plurality of battery cells each having a plurality of cell terminals, the battery cells being retained within the matrix of recesses of the at least one retaining cell carrier and at least a subset of the plurality of cell terminals extending through the openings of the bottom wall of the at least one perforated cell carrier; and a plurality of electrically conductive interconnecting members each being electrically coupled to at least two of the cell terminals of the plurality of battery cells extending through the openings of the at least one perforated cell carrier and providing an electrical interconnection therebetween.

In at least some embodiments, the matrix of recesses are arranged to retain adjacent battery cells spaced apart from one another to allow for heat dissipation and reducing short circuiting between the adjacent battery cells.

In at least some embodiments, the first cell carrier is a retaining cell carrier and the second cell carrier is a retaining cell carrier.

In at least some embodiments, the first cell carrier retains a first end region of the plurality of battery cells and the second cell carrier retains a second end region of the plurality of battery cells; and the recesses of the first cell carrier are aligned with corresponding recesses of the second cell carrier.

In at least some embodiments, the perforated cell carrier is also a retaining cell carrier.

In at least some embodiments, a first subset of the cell terminals of the plurality of battery cells are located at a first end of the battery cells and a second subset of the cell terminals of the plurality of battery cells are located at a second end of the battery cells, the first and second cell carriers are perforated cell carriers, and the first subset of the cell terminals extend through the openings of the first perforated cell carrier and the second subset of the cell terminals extend through the openings of the second perforated cell carrier.

In at least some embodiments, the at least one perforated cell carrier further comprises a plurality of rupture openings that are configured to permit passage therethrough of material released from a pressure release burst disc of a corresponding battery cell if the corresponding battery cell has a pressure rupture during use.

In at least some embodiments, the battery pack assembly further comprises a retaining member for releasably holding together the first cell carrier, the second cell carrier, and the plurality of battery cells therebetween.

In at least some embodiments, the retaining member extends over outer surfaces of the first and second cell carriers across a length of the battery cells and over exterior surfaces of first and last positioned battery cells.

In at least some embodiments, at least one of the electrically conductive interconnecting elements comprise bus bars that are coupled to the at least two cell terminals of the battery cells being interconnected by the bus bars.

In at least some embodiments, at least one of the first and second cell carriers is formed of polyoxymethylene.

In at least some embodiments, the battery pack assembly further comprises at least one measurement board including: a supporting layer having printed circuit traces thereon; a signal port coupled to the printed circuit traces; and at least one sensor for sensing information about the battery cells during operation.

In at least some embodiments, the at least one sensor comprises at least one temperature sensor extending from a first surface of the supporting layer and coupled with the signal port via the printed circuit traces.

In at least some embodiments, the first surface of the supporting layer is disposed against an outer surface of one of the first and second cell carriers and the at least one temperature sensor extends through at least one sensor opening in the outer surface of the one of the first and second cell carriers and is positioned near at least one of the battery cells for measuring battery temperature thereof during use.

In at least some embodiments, the at least one sensor comprises at least one first contact for electrically contacting a first one of the plurality of cell terminals of the battery cells and at least one second contact for electrically contacting a second one of the plurality of cell terminals of the battery cells, the at least one first and second contacts being coupled to the signal port via the printed circuit traces.

In at least some embodiments, the at least one first contact and the at least one second contact are resilient members.

In at least some embodiments, the supporting layer of the at least one measurement board comprises one or more openings and is disposed against an outer surface of one of the first and second cell carriers and the outer surface of said one of the first and second cell carriers comprises one or more corresponding standoffs that cooperate with the one or more openings to hold the at least one measurement board in place with respect to the one of the first and second cell carriers.

In at least some embodiments, the battery pack assembly further comprises a first measurement board aligned with a first column of the plurality of battery cells and a second measurement board aligned with a second column of the plurality of battery cells.

In at least some embodiments, the battery pack assembly further comprises a battery management system board in signal communication with the signal port of the at least one measurement board for coupling with an external battery management system.

In at least some embodiments, the battery management system board is disposed in a first plane adjacent to an end plate at one end of the plurality of battery cells and the at least one measurement board is disposed in a second plane adjacent to one of the first and second cell carriers.

In at least some embodiments, the battery pack assembly further comprises an enclosure for enclosing the first and second cell carriers and the plurality of battery cells therebetween; and first and second pack terminals being electrically coupled to at least one first and at least one second cell terminals via first and second output bus bars, respectively, the first pack terminal and the second pack terminal providing contacts for coupling to an external electrical device.

In at least some embodiments, the battery pack assembly may further comprise an enclosure having enclosure walls for enclosing the first and second cell carrier and the plurality of battery cells therebetween, wherein at least one of the enclosure walls comprises at least one connecting groove for receiving a portion of at least one pack connector to couple the battery pack assembly with another battery pack assembly, the at least one connecting groove having a shape corresponding to an end of the at least one pack connector, the shape being and end of an I-shape or a C-shape.

In another broad aspect, at least one of the embodiments described herein provides a battery pack system comprising at least one pack connector for coupling two battery pack assemblies together; a first battery pack assembly including: a first battery pack enclosure having a first enclosure wall with at least one connecting groove having a shape corresponding to a first end of the at least one pack connector; and a first battery pack sub-assembly disposed within the first battery pack enclosure; and a second battery pack assembly including: a second battery pack enclosure having a second enclosure wall that is disposed adjacent to the first enclosure wall of the first battery pack assembly, the second enclosure having at least one connecting groove with a shape corresponding to a second end of the at least one pack connector; and a second battery pack sub-assembly disposed within the second battery pack enclosure.

In at least some embodiments, each end of the at least one pack connector comprises a flange.

In at least some embodiments, the at least one pack connector has a cross-section comprising an I-shape or a C-shape.

In another broad aspect, at least one of the embodiments described herein provides a battery pack sub-assembly comprising: a plurality of battery cells being arranged in a spaced apart fashion between first and second cell carriers; and at least one measurement board comprising a supporting layer having printed circuit traces thereon, a signal port, and at least one sensor electrically coupled to the signal port via the printed circuit traces and extending from a first surface of the supporting layer towards at least one of the battery cells for measuring information therefrom during operation.

In at least some embodiments, the at least one sensor comprises at least one temperature sensor extending from the first surface of the supporting layer through one of the first and second cell carriers towards the at least one of the battery cells for measuring temperature thereof during use.

In at least some embodiments, the least one sensor comprises at least one first contact for electrically contacting at least a first cell terminal from the plurality of battery cells and at least one second contact for electrically contacting at least a second cell terminal from the plurality of battery cells.

In at least some embodiments, the battery pack assembly further comprises at least one battery management terminal in signal communication with the signal port of the at least one measurement board for electrical coupling with a battery management system board.

In another broad aspect, at least one of the embodiments described herein provides method of manufacturing a battery pack sub-assembly, the method comprising: positioning a first cell carrier adjacent to first ends of a plurality of battery cells; positioning a second cell carrier adjacent to second ends of the plurality of battery cells; retaining at least one of the first ends and the second ends of the plurality of battery cells within a matrix of recesses of at least one of the first cell carrier and the second cell carrier; extending a plurality of cell terminals of the plurality of battery cells extend through terminal openings of at least one of the first cell carrier and the second cell carrier; coupling a plurality of electrically conductive interconnecting elements to the plurality of cell terminals that extend through the terminal openings of the at least one of the first cell carrier and the second cell carrier according to a predetermined circuit configuration for the plurality of battery cells.

In at least some embodiments, at least one of the electrically conductive interconnecting elements comprises a bus bar that is laser welded to at least two cell terminals of the plurality of cell terminals.

In at least some embodiments, the method further comprises retaining the first cell carrier, the second cell carrier and the plurality of battery cells in a fixed position using at least one strap extending thereabout.

In at least some embodiments, the method further comprises positioning at least one measurement board having at least one sensor over an outer surface of one of the first cell carrier and the second cell carrier to extend the at least one sensor towards the at least one of the plurality of battery cells.

In at least some embodiments, the at least one sensor comprises at least one temperature sensor that extends from the at least one measurement board through at least one opening of the one of the first cell carrier and the second cell carrier to be positioned amidst the battery cells.

In at least some embodiments, the at least one sensor comprises at least first and second contacts and the method comprises positioning the at least one measurement board over an outer surface of one of the first cell carrier and the second cell carrier to electrically couple the at least one first contact with at least one of the plurality of electrically conductive interconnecting elements and the at least one second contact with at least one other of the plurality of electrically conductive interconnecting elements.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described.

FIGS. 1A and 1B show example embodiments of rectangular and cylindrical battery cells, respectively, that may be used in a battery pack system.

FIGS. 2A and 2B show example embodiments of cell and bus bar assemblies using rectangular and cylindrical battery cells, respectively, that may be used in a battery pack system.

FIGS. 3A and 3B show example embodiments of cell carriers that may be used in a battery pack sub-assembly.

FIGS. 4A and 4B show perspective front and rear views, respectively of an example embodiment of an end plate that may be used in a battery pack sub-assembly.

FIG. 5 shows an exploded view of an example embodiment of a battery pack sub-assembly.

FIG. 6 shows the battery pack sub-assembly of FIG. 5 partially assembled and before installation of the bus bars.

FIG. 7 shows the battery pack assembly of FIG. 6 after installation of the bus bars.

FIGS. 8A and 8B show the exterior and interior surfaces of an example embodiment of battery measurement board that may be used in a battery pack system.

FIG. 9 shows an example of the battery pack sub-assembly electronics that may be used in a battery pack system.

FIGS. 10A and 10B show front and rear views, respectively, of an example embodiment of a rear end plate that may be used in a battery pack system.

FIG. 11 shows an example embodiment of a power pack terminal that may be used in a battery pack system.

FIGS. 12A and 12B show a perspective view of an exterior surface and an interior surface, respectively, of an example embodiment of an end plate that may be used in a battery pack system.

FIG. 13 shows an example embodiment of the outer walls of a battery pack enclosure assembly that may be used in a battery pack system.

FIG. 14 shows an example embodiment of battery cell enclosure assembly components that may be used in a battery pack system.

FIG. 15 shows an exploded view of an example embodiment of a battery pack system.

FIG. 16 shows a partially exploded view of an example embodiment of a battery pack system without electronics.

FIG. 17 shows bus bar connections to external connectors for an example embodiment of a partially assembled battery pack system.

FIG. 18 shows an example embodiment of a fully assembled battery pack system.

FIGS. 19A and 19B respectively show a perspective view of a fully assembled battery pack system according to an example embodiment and an example alternative embodiment.

FIG. 20 shows a front elevation view of two enclosure walls being interconnected by a pack connector according to an example embodiment.

FIG. 21 shows a perspective view of a plurality of interconnected assembled battery pack systems according to an example embodiment.

FIG. 22 shows a perspective view of a plurality of interconnected assembled battery pack systems according to an example embodiment.

Further aspects and features of the embodiments described herein will appear from the following description taken together with the accompanying drawings.

### DESCRIPTION OF VARIOUS EMBODIMENTS

Various apparatuses or processes will be described below to provide an example of at least one embodiment of the claimed subject matter. No embodiment described below limits any claimed subject matter and any claimed subject matter may cover processes, apparatuses or systems that differ from those described below. The claimed subject matter is not limited to apparatuses, processes or systems having all of the features of any one apparatus, process or system described below or to features common to multiple or all of the apparatuses, or processes or systems described below. It is possible that an apparatus, process or system described below is not an embodiment of any claimed subject matter. Any subject matter that is disclosed in an apparatus, process or system described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical element or electrical signal or a mechanical element depending on the particular context.

It should be noted that terms of degree such as “substantially”, “about” and “approximately” as used herein mean a reasonable amount of deviation of the modified term such that the end result is not significantly changed. These terms of degree may be construed as including a certain deviation of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made if the end result is not significantly changed.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

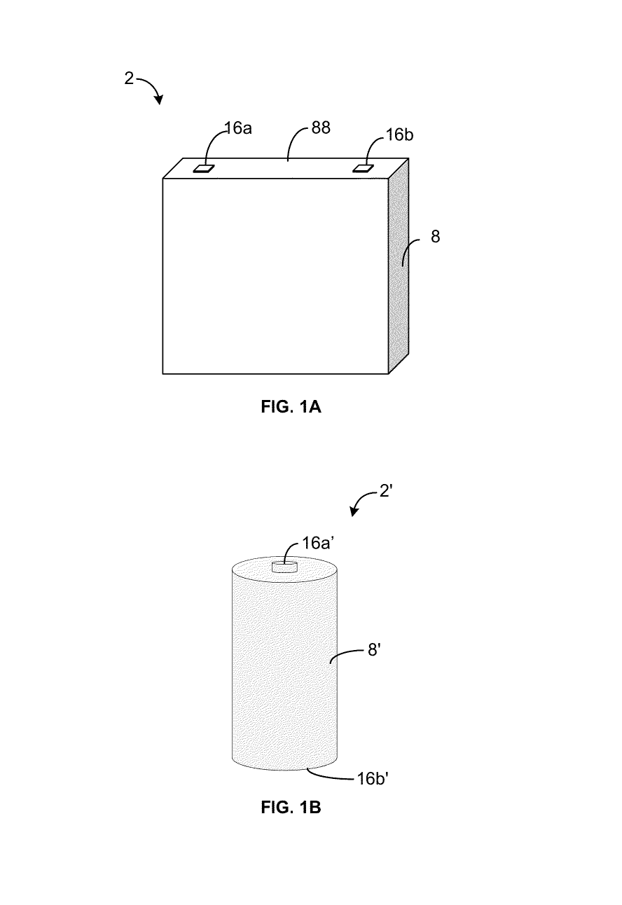

Referring now to FIGS. 1A and 1B shown therein are example embodiments of rectangular and cylindrical battery cells 2 and 2′, respectively, which may be used in a battery pack system. The battery cell 2 includes a cell body 8 and at least two cell terminals 16a and 16b. Likewise, the battery cell 2′ includes a cell body 8′ and at least two cell terminals 16a′ and 16b′. The cell body 8, 8′ stores chemical energy which may be converted into electrical energy and discharged through the cell terminals 16a, 16a′ and 16b, 16b′. As is in the known art, a battery cell may generally have various form factors such as a pouch, a canister (FIG. 1A) and a cylinder (FIG. 1B). Within a given form factor, a battery cell may also have various sizes. The cell terminals of a battery cell 2 may be on the same end of a battery cell, such as the canister cell 2 shown in FIG. 1A, or on different ends of the battery cells such as the opposite ends of the cylinder battery cell 2′ of FIG. 1B.

The battery cells 2 and 2′ may be large format lithium or other chemistry-based battery cells. For example, the battery cells 2 and/or 2′ may be, but are not limited to being, Toshiba 20A/H SCIB Li-Titanate cells, Winston Lithium Iron Phosphate 260A/H cells or A123 AHR32113 Lithium Iron Phosphate.

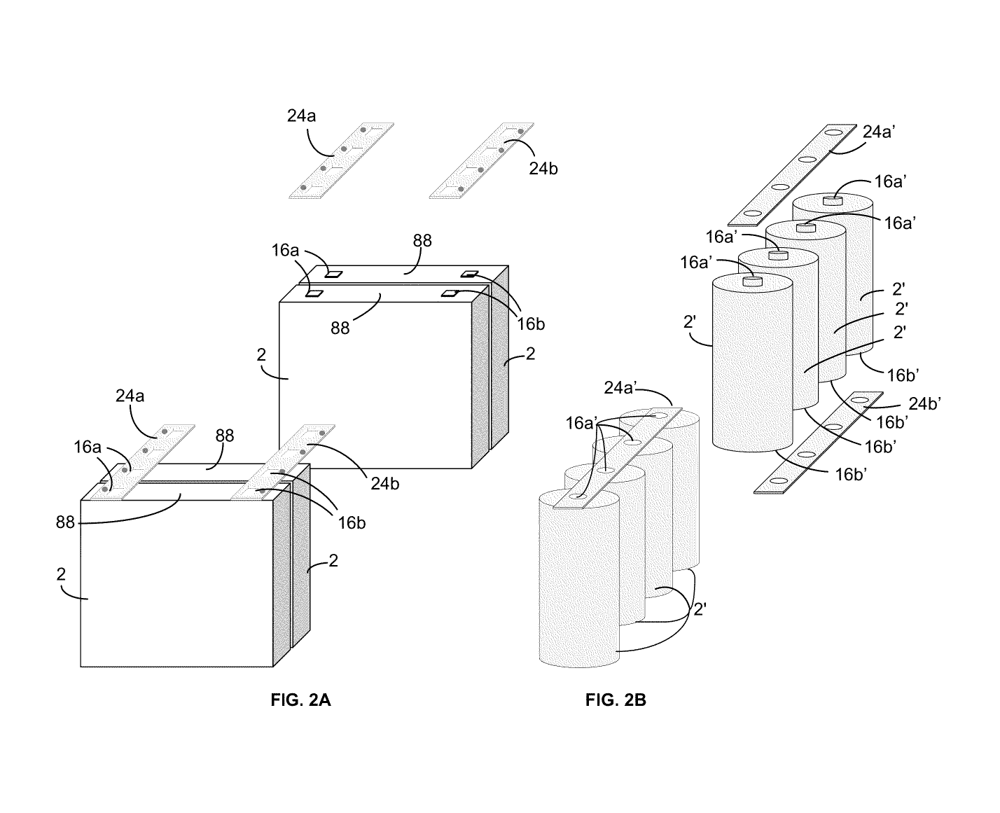

Referring now to FIGS. 2A and 2B, shown therein are example embodiments of cell and bus bar assemblies using the rectangular and cylindrical battery cells 2 and 2′, respectively. As shown in FIG. 2B, the terminals 16a and 16b of two or more battery cells 2 may be interconnected according to a desired configuration, which may be a series connection, parallel connection, or mixed series and parallel connection. Various electrically conductive interconnecting elements 24 known in the art may be used to interconnect the cell terminals 16a and 16b, such as bus bars, wires, spot welding tabs to the cell terminals, soldering wires to spot welded material, etc. The electrically conductive interconnecting elements 24 may also be coupled to the cell terminals 16a and 16b according to various methods known in the art which are appropriate to the size of the cell terminals 16a and 16b such as, but not limited to, welding, soldering and attaching a lug to a cell terminal for example. The cell terminals 16a and 16b may be threaded and the lug may have threading matching the cell terminals 16a and 16b.

As illustrated in FIG. 2A, bus bars 24a and 24b interconnect cell terminals 16a and 16b, respectively of the canister battery cells 2. The cell terminals 16a and 16b of the canister battery cells 2 are both located on a top side of the battery cell body 8 and therefore the bus bars 24a and 24b are also positioned on the top side of the battery cell body 8.

As illustrated in FIG. 2B, bus bars 24a′ and 24b′ are aligned with similarly signed cell terminals 16a′ and 16b′ of cylinder battery cells 2′. The cell terminals 16a′ and 16b′ of the cylinder battery cells 2′ are located on opposite sides of the battery cell body 8′ and therefore the bus bars 24a′ and 24b′ are positioned on opposite ends of the battery cell body 8′.

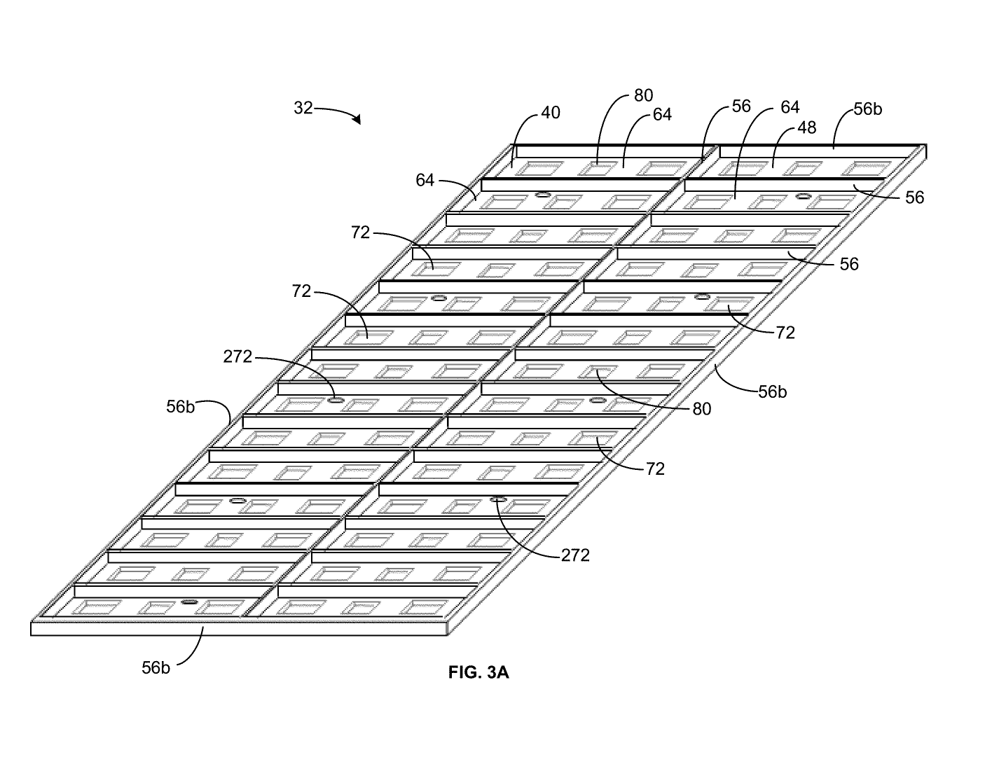

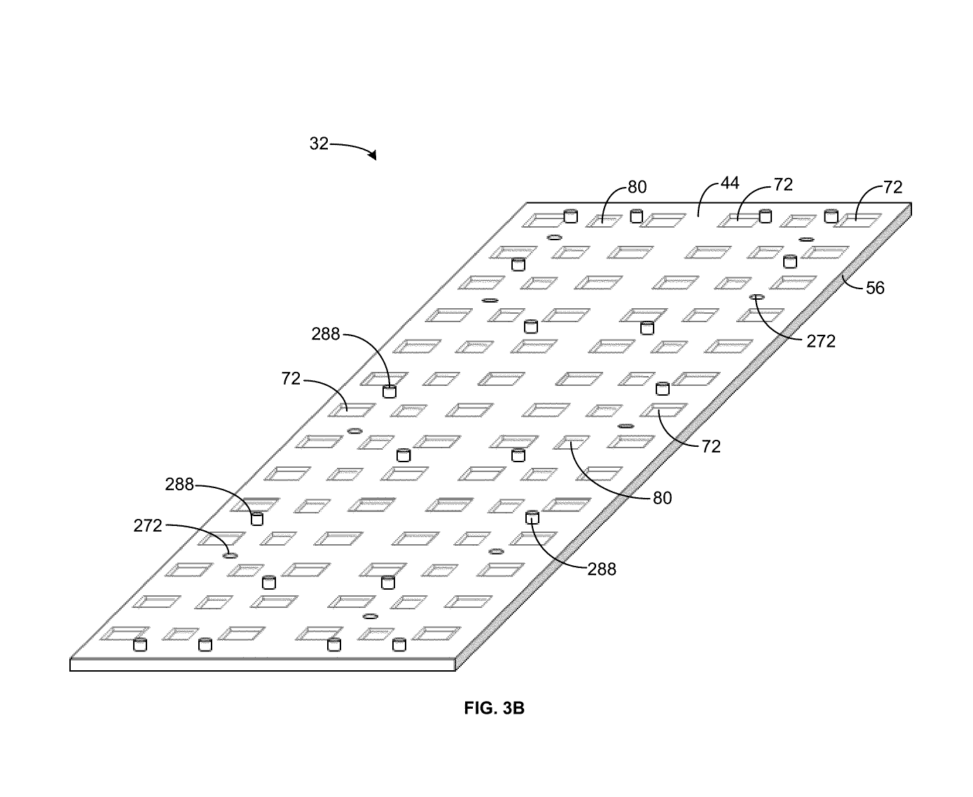

Referring now to FIGS. 3A and 3B simultaneously, therein illustrated is a perspective view of an example embodiment of a cell carrier 32 that may be used in a battery pack sub-assembly. The cell carrier 32 illustrated in FIG. 3A is oriented in such a way so as to show the interior surface 40 of the cell carrier 32. The cell carrier 32 illustrated in FIG. 3B is oriented in such a way so as to show the exterior surface 44 of the cell carrier 32. It should be noted that the interior surface 40 of the cell carrier 32 refers to the surface that will be oriented towards the battery cells 2 and away from the enclosure walls of the battery pack when the battery pack is assembled. It should also be noted that the exterior surface 44 of the cell carrier refers to the surface that will be oriented away from the battery cells 2 and towards the enclosure walls when the battery pack is assembled.

There may be alternative embodiments in which the cell carrier 32 is adapted for use with the battery cells 2′. There may also be other alternative embodiments in which other cells with different sizes and shapes may be used along with the cell carriers described herein. In other words, the size and shape of the cell carriers described herein may be adapted to complement the shape and size of the battery cells.

The cell carrier 32 can be a retaining cell carrier, a perforated cell carrier, or both a retaining cell and a perforated cell depending on its configuration. Generally, a retaining cell carrier is one which has structural elements that rigidly hold the battery cells in place during use and also hold the battery cells in a spaced apart fashion to allow for heat dissipation between adjacent battery cells and to reduce the likelihood of electrical shorting between adjacent battery cells. A perforated cell is one which has apertures or holes that allow battery terminals of the battery cells to protrude therethrough. A cell carrier that is a perforated retaining cell carrier generally has the structural features and functionality of both retaining cell carriers and perforated cell carriers.

In general a retaining cell carrier has a bottom wall 48 and a plurality of upstanding walls 56 extending from the bottom wall 48. The upstanding walls 56 and the bottom wall 48 define a plurality of recesses 64 only some of which are labelled for ease of illustration. As illustrated, the recesses 64 are arranged in a matrix format. Each recess 64 may be sized according to the size and form factor of the battery cells 2 to be received within the recess 64 with certain tolerances to account for manufacturing variation. For example, and as illustrated, the upstanding walls 56 and the bottom wall 48 define rectangular recesses 64 for receiving the canister cells 2 illustrated in FIG. 1A.

According to this example embodiment, a battery cell 2 is received in a recess 64 so that it fits snugly within that recess 64. Accordingly the battery cell 2 is retained in position within the recess 64 during use. The snug fit of the battery cell 2 can be useful to reduce vibration forces that may be translated to the battery cell 2 due to movement of a battery pack system containing the battery cell 2 during use.

The thickness of the upstanding walls 56 also creates a physical separation between battery cells that are retained in adjacent recesses 64. Therefore, the upstanding walls 56 restrict physical contact between battery cells that are retained in adjacent recesses 64, thereby reducing the likelihood of short circuits between adjacent battery cells during use since the battery cells 2 may be electrically conductive around their edges and may otherwise be prone to short circuiting. Such short-circuiting would cause a catastrophic failure of the battery pack system if not addressed appropriately. There are also upstanding boundary walls 56b (also known as isolation walls) that may be designed to physically space the battery cells 2 away from surrounding walls of the enclosure or housing of the battery pack system thereby providing electrical isolation between the housing of the battery pack system and the battery cells 2.

Furthermore, the separation between the battery cells 2 retained in adjacent recesses 64 due to the upstanding walls 56 provides fluid channels between the cell bodies 8 of the battery cells 2, thereby improving thermal dissipation of heat emitted from the battery cells 2 during use thereby promoting cooling. The thickness of the upstanding walls 56 and the size of the recesses 64 may also be chosen to provide accurate and repeatable spacing between the battery cells and allow the battery cells to expand during various thermal cycles while in operation as well as provide cell isolation during an event which may cause thermal reactions to adjacent battery cells, as per cell manufacturer recommendations.

The upstanding walls 56 and 56b also address other issues with battery pack systems that use several adjacent cells which include a chain reaction that may happen when a single battery cell outgasses and gets extremely hot when that battery cell fails or is presented with a short which may be caused by the manufacturing process. This is more prevalent with cell chemistries that have oxide or oxygen which acts as a fuel with the lithium when the battery cell starts to burn. Advantageously, the battery cell carriers 32 use the upstanding walls 56 and 56b to form a matrix that may be used to isolate battery cells from adjacent battery cells. In particular, the matrix indexes each battery cell in a controlled environment thereby preventing a battery cell which is outgassing or flaming to affect adjacent battery cells and start a chain reaction which can devastate the entire battery pack system.

The upstanding walls 56 and the bottom wall 48 of the retaining cell carrier 32 may be further configured according to predetermined requirements of the battery pack system that the cell carrier 32 is to be used in. For example, the recesses 64 may be arranged in a side by side fashion, so that the battery cells 2 retained therein are also arranged side-by-side. Accordingly, the battery cells 2 have a substantially planar configuration.

Furthermore, the retaining cell carrier 32 may have a different number of recesses 64 according to a predetermined number of battery cells 2 to be included in a battery pack system. For example, the retaining cell carrier 32 can have a different arrangement of rows and columns of recesses 64. As illustrated in FIG. 3A, the retaining cell carrier 32 has a 2×14 configuration for a total of 28 recesses. In general, the matrix may have N columns and M rows where N and M are integers greater than or equal to 1.

In a perforated cell carrier, the bottom wall 48 also includes a plurality of first openings 72 formed therethrough. The plurality of openings 72 are shaped and/or sized according to the size and/or shape of the cell terminals 16a, 16a′ and 16b, 16b′ of the battery cells 2, 2′ to be included in the battery pack system. As illustrated, the openings 72 are rectangular to accommodate the rectangular terminals 16a and 16b of the canister battery cells 2 of FIG. 1A. However, it will be understood that the openings 72 may have any other appropriate shape and/or size, such as being circular to receive the circular terminals 16a′ and 16b′ of the cylinder battery cells 2′ of FIG. 2B.

The bottom wall 48 of the perforated cell carrier has a thickness that is chosen according to the height of the cell terminals 16a and 16b of the battery cells 2 to be used. The height of the cell terminals 16a and 16b refers to the length at which the cell terminals 16a and 16b extend from an upper surface of the cell body 8 of the battery cell 2. For example, the thickness of the bottom wall 48 of the perforated cell carrier is chosen to be less than (i.e. thinner) than the height of the cell terminals 16a and 16b. Consequently, the cell terminals 16a and 16b that extend through openings 72 protrudes through and above the exterior surface 44 of the cell carrier 32. The protrusion of the cell terminals 16a and 16b allows the cell terminals 16a and 16b to be electrically coupled by one or more electrically conductive interconnecting elements 24 that are located above the exterior surface 44. A similar situation happens with the cylindrical battery cells 2′ and the battery cell terminals 16a′ and 16b′ except it is with respect to openings 72 on both upper and lower cell carriers at either end of the battery cells 2′.

The bottom wall 48 may further have second openings 80. The second openings 80 act as rupture openings to provide passage therethrough of material that may be released from one or more battery cells 2 that may burst during use. Accordingly, the second openings 80 are aligned with pressure release burst discs 88 (FIG. 1A) of the battery cells 2. It should be noted that the rupture openings may be optional in certain embodiments depending on the type of cells used and the operating range for the battery cells.

The cell carrier 32 (whether acting as a retaining cell carrier or a perforated cell carrier) generally may be made using a non-electrically conductive and heat resistant material. For example, the cell carrier 32 may be formed of polyoxymethyline (e.g. Delrin™). The battery cell carriers 32 may also be manufactured in several mediums such as, but not limited to, metals, plastics, ceramics, graphite and composites, for example, depending on environmental and thermal requirements. The cell carriers 32 may also be made from a low cost injected plastic matrix.

It will be appreciated that the cell carrier 32 illustrated in FIG. 3 is both a retaining cell carrier and a perforated cell carrier in that it includes both upstanding walls 56 for defining the plurality of recesses 64 and the openings 72 for receiving cell terminals 16a and 16b.

It should be noted that the cell carriers 32, which may be made at low cost, provide ease in manufacturing as cell carriers can be made such that the same cell carrier can function as both a top and a bottom cell carrier in at least some embodiments.

It should also be noted that the matrix of recesses 64 may be made to index the battery cell terminals for connections with interconnecting elements, like bus bars, for allowing manufacturers stringent welding requirements through the use of automated indexing and welding systems in embodiments in which welding is used.

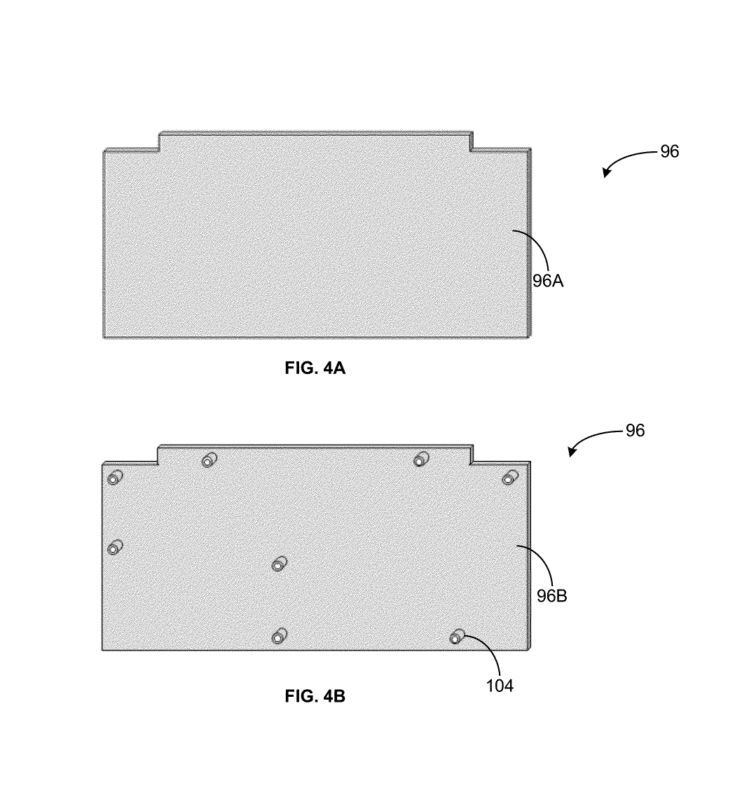

Referring now to FIGS. 4A and 4B, therein illustrated are perspective front and rear views, respectively, of an example embodiment of an end plate 96 that may be used in a battery pack sub-assembly. A first surface 96A of the end plate 96 may be flat while a second surface 96B of the end plate 96 may include mounting provisions 104 for mounting another planar member, such as a battery management system board, for example. Two of the end plates 96 may be placed at either end of the cell carriers in a coplanar fashion with the vertical axes of the battery cells 2. For example, two end plates 96 may be adjacent to opposite ends of the cell carriers 32 and fixed in position. Accordingly, in some embodiments, the width of the end plate 96 may be chosen to correspond with a width of the retaining crate. The height of the end plate 96 may be generally chosen to correspond to the height of the battery cells 2 to be included in the battery pack. Also, in some embodiments one of the end plates 96 may have both surfaces similar to surface 96A.

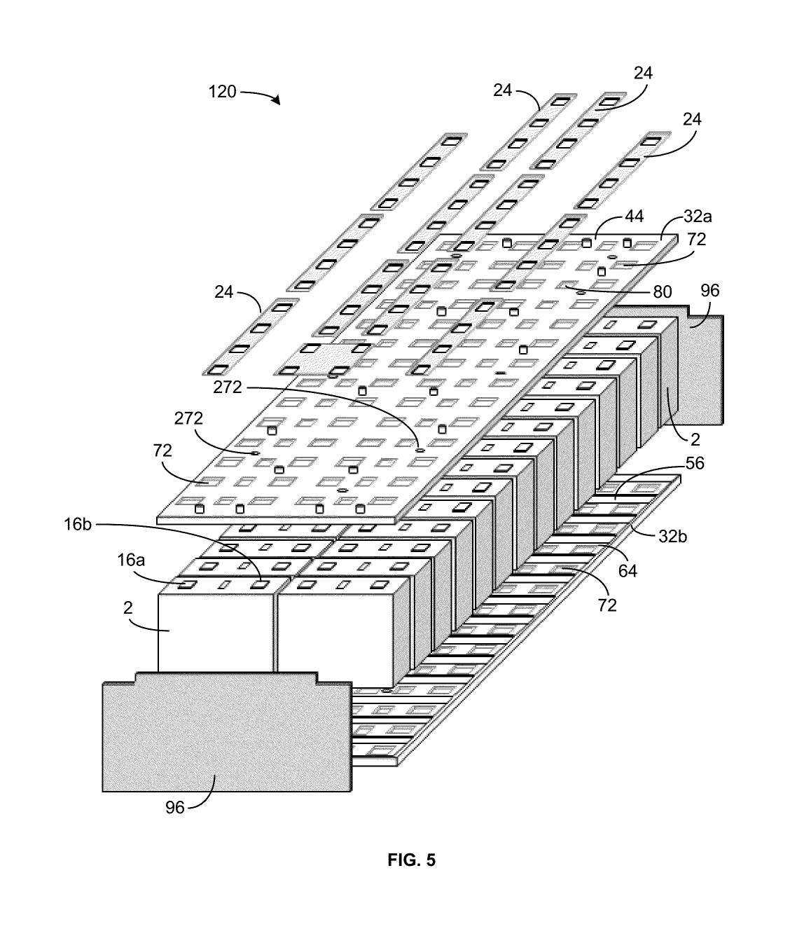

Referring now to FIG. 5, therein illustrated is a perspective exploded view of an example embodiment of a battery pack cell sub-assembly 120. The battery cell sub-assembly 120 includes a first cell carrier 32a, a second cell carrier 32b and a plurality of battery cells 2 positioned between the first cell carrier 32a and the second cell carrier 32b.

In general, at least one of the first cell carrier 32a and the second cell carrier 32b is a retaining cell carrier (in this case, the other cell carrier may be a perforated cell carrier in which openings for battery cell terminals are sized to also hold the battery cells in place). The plurality of battery cells 2 are received within the recesses 64 of the retaining cell carrier. In some embodiments, both of the cell carriers 32a and 32b may be retaining cell carriers to more firmly hold the battery cells in place.

In general, at least one of the first cell carrier 32 and the second cell carrier 32b is a perforated cell carrier (e.g.: for cases in which the battery cell terminals and pressure rupture discs are on one end of the battery cell such as for the battery cell 2). The perforated cell carrier is positioned so that its openings 72 are aligned with the cell terminals 16a and 16b. The perforated cell carrier can then be disposed against the battery cells 2 so that the cell terminals 16a and 16b extend into corresponding openings 72 of the perforated cell carrier.

According to at least some embodiments, the first cell carrier 32a and the second cell carrier 32b are both retaining cell carriers. As illustrated, the first cell carrier 32a may be oriented so that its upstanding walls 56 extend toward end surfaces for one end of the battery cells 2. As further illustrated, the second cell carrier 32a may also be oriented so that its upstanding walls 56 extend toward end surface for a second end of the battery cells 2 where the second end generally is in an opposite direction to the first end.

As further illustrated, the first cell carrier 32a may be aligned with a top region of the battery cells 2 and the second cell carrier 32 may be aligned with a bottom region of the battery cells 2. For example, the recesses 64 of the first retaining cell carrier 32a may be aligned with corresponding recesses 64 of the second retaining cell carrier 32b. Each pair of aligned recesses 64 of the first and second retaining cell carriers 32a and 32b function together to retain one battery cell 2 of the plurality of battery cells 2. It will be appreciated that if the first cell carrier 32a and the second cell carrier 32b are both retaining cell carriers, they can provide improved reduction of vibration forces that may be applied to the battery cells 2 as well as provide improved reduction of short circuiting between adjacent battery cells 2.

In this example embodiment, the battery cell sub-assembly 120 may further include the end plates 96 that are positioned at respective ends of the first and second cell carriers 32a and 32b. The end plates 96 can improve structural rigidity of the sub-assembly 120 as well as provide mounting provisions for attaching additional members thereto.

The battery cell sub-assembly 12 further includes electrically conductive interconnecting elements 24, such as bus bars 24. The electrically conductive interconnecting elements 24 may be positioned over the exterior surface 44 of the perforated cell carrier to interconnect the battery cell terminals 16a and 16b that extend through the openings 72 of the perforated cell carrier 32. For example, and as illustrated in FIG. 5, a plurality of bus bars 24 are positioned over the exterior surface 44 of the first cell carrier 32a to interconnect terminals 16a and 16b located at the top side of various battery cells to connect the battery cells in a series, parallel or series and parallel connection.

According to various example embodiments, and as illustrated in the figures, the cell terminals 16a and 16b of each of the battery cells 2 are located at a same end of the battery cells 2. Accordingly, the electrically conductive interconnecting elements 24 only need to be positioned on the exterior surface 44 of the cell carrier through which the battery cell terminals 16a and 16b protrude in order to couple one or more of the battery cell terminals 16.

According to another example embodiment, the cell terminals 16a′ and 16b′ of the battery cells 2′ are located on opposite ends of the battery cell body 8′. Therefore, for example, in a battery pack assembly, a first subset of the battery cell terminals 16a′ of a plurality of battery cells 2′ are located at a first end of the battery cells 2′ and a second subset of the battery cell terminals 16b′ of the plurality of battery cells 2′ are located at a second end of the battery cells 2′. Accordingly, in this case, the first cell carrier 32a and the second cell carrier 32b are both perforated cell carriers. The first subset of the battery cell terminals 16a′ extend through corresponding openings 72 of the first perforated cell carrier 32a and the second subset of the battery cell terminals 16b′ extend through corresponding openings 72 of the second perforated cell carrier. In this case, the interconnecting elements 24 may be positioned on the outer surfaces of both of the cell carriers 32a and 32b for coupling with the battery cell terminals 16a′ and 16b′, respectively.

In at least some embodiment, the interconnecting elements, in this example embodiment bus bars, are made from conducting materials and may be welded to the positive and negative battery cell terminals after the battery cells are retained between the cell carriers 32a and 32b. This allows for rapid X, Y and Z gantry welding to be performed with a pre-programmed layout such as that shown in FIGS. 2A and 2B, for example.

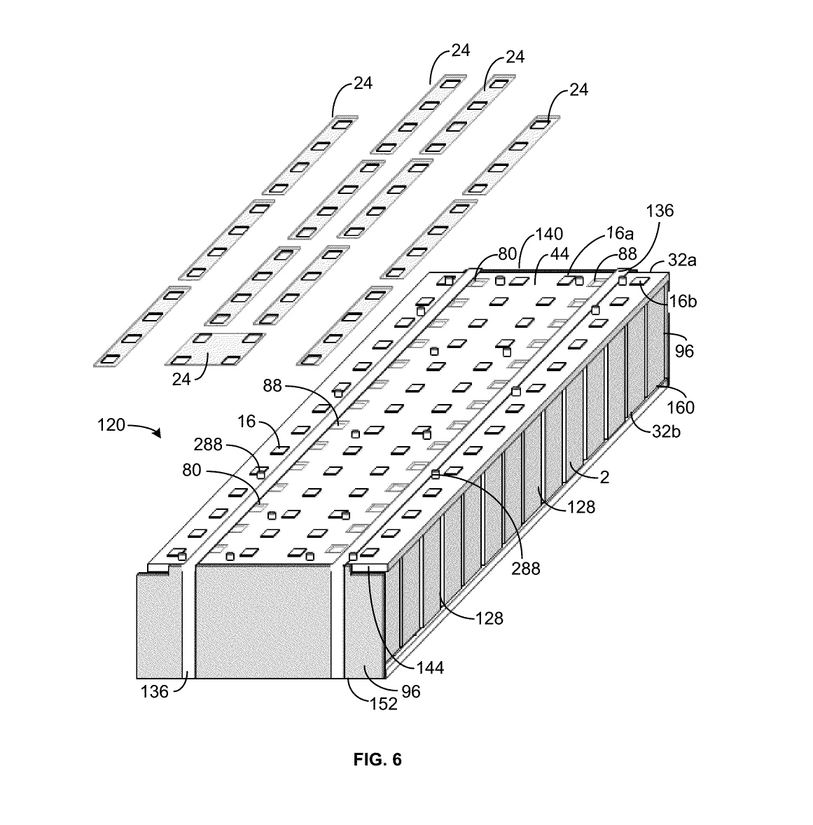

Referring now to FIG. 6, therein illustrated is a perspective view of a partially assembled battery cell sub-assembly 120 before installation of the interconnecting elements 24. The plurality of battery cells 2 are retained between the first cell carrier 32a and the second cell carrier 32b. The battery cell terminals 16a and 16b of the battery cells 2 protrude from the exterior surface 44 of the first cell carrier 32a, which is a perforated cell carrier. Due to the plurality of battery cells 2 being retained within the recesses 64 of the retaining cell carrier and being separated by the upstanding walls 56, a plurality of gaps 128 are defined between the battery cells 2 through which heat may be dissipated during use. The gaps 128 also create a distance between adjacent battery cells 2, thereby reducing the possibility of short circuiting between adjacent battery cells 2. The end plates 96 are positioned at the ends of the first and second cell carriers 32a and 32b.

The partially assembled battery cell sub-assembly 120 further includes at least one retaining member 136 for holding together the first cell carrier 32a, the second cell carrier 32b and the plurality of battery cells 2 disposed therebetween. The retaining member 136 can further hold the end plates 96 in place on either end of the battery cell sub-assembly 120. In this example embodiment, the retaining member 136 comprises two strappings although other objects may be used in other embodiments.

According to this example embodiment illustrated in FIG. 6, the retaining member 136 includes at least one strap that extends over opposite ends of an exterior surface 44 of the first cell carrier 32a (e.g.: from a second side 140 to a first side 144), between a first side 144 of the first cell carrier 32a and a corresponding first side 152 of the second cell carrier 32b, over opposite ends of an exterior surface of the second cell carrier 32b (e.g.: from the first side 152 to a second side 160) and from a second side 164 of the second cell carrier 32b and the corresponding second side 140 of the first cell carrier 32a. It should be noted that when the retaining member 136 extends between corresponding ends of the first and second cell carriers 32a and 32b, the retaining member 136 is running along the length of the battery cells 2. For example, the retaining member 136 extends over a surface of the end plates 96. The retaining member 136 is positioned so the second openings 88 remain unobstructed.

The partially assembled battery cell sub-assembly 120 illustrated in FIG. 6 is in a state that is ready for receiving the electrically conductive interconnecting elements 24. The battery cell terminals 16 of the battery cells 2 can be coupled by the interconnecting elements 24 according to a desired specification of the battery pack system which may require that the battery cells 2 be coupled in series, in parallel or a combination of series and parallel connections. For example, as illustrated in FIG. 6, the interconnecting elements 24 may be disposed in order to couple sets of two battery cells 2 in parallel and further couple the sets in series. There may also be other embodiments in which there are a larger number of battery cells that may be coupled in various parallel and series configurations.

According to one example, the partially assembled battery cell sub-assembly 120 illustrated in FIG. 6 may represent a state in which the battery cell sub-assembly is ready to be delivered to a site for installation. For example, a manufacturer may first provide the partially assembled battery cell sub-assembly 120. A downstream solutions provider can then provide a “customized” battery pack solution by interconnecting the battery cell terminals 16a and 16b according to a desired configuration (i.e. series and/or parallel connection).

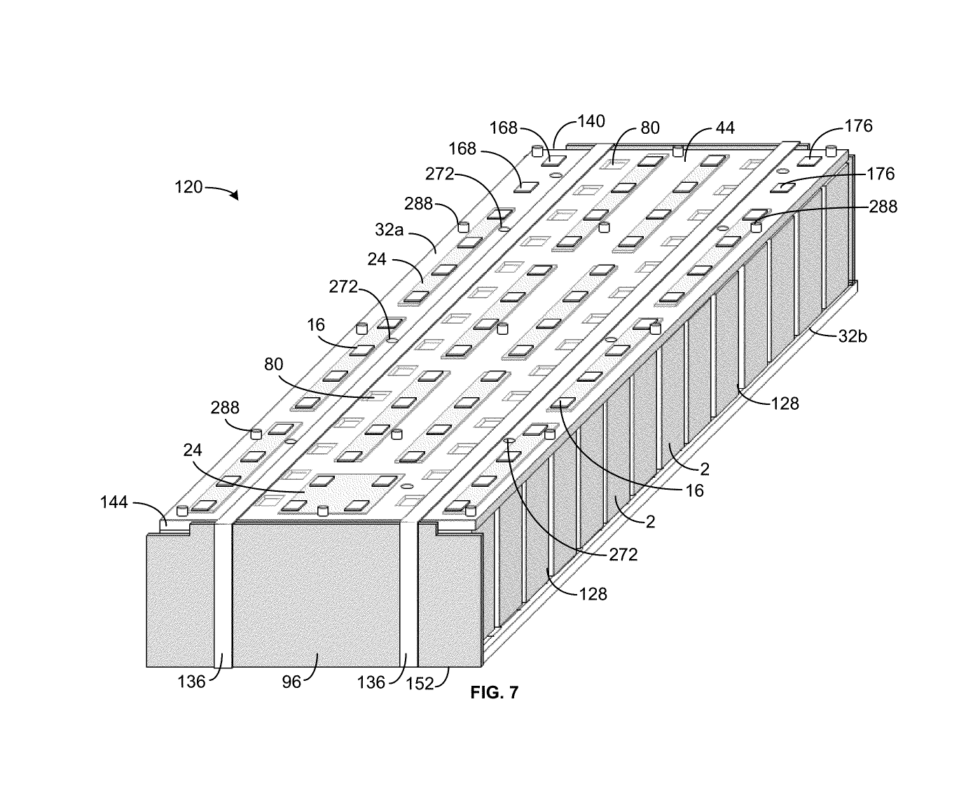

Referring now to FIG. 7, therein illustrated is a perspective view of the battery cell assembly 120 after installation of the interconnecting elements 24 over the exterior surface 44 of the first cell carrier 32a according to one example embodiment. For example, the electrically conductive interconnecting elements 24 may be bus bars that are welded to the battery cell terminals 16a and 16b according to a desired configuration. More particularly, the bus bars 24 may be laser welded to the battery cell terminals 16a and 16b or interconnected by wires. As described above, sets of two battery cells 2 connected in parallel may further be coupled together in series or in parallel. However, it will be understood that any other suitable interconnection of the battery cells 2 may be implemented.

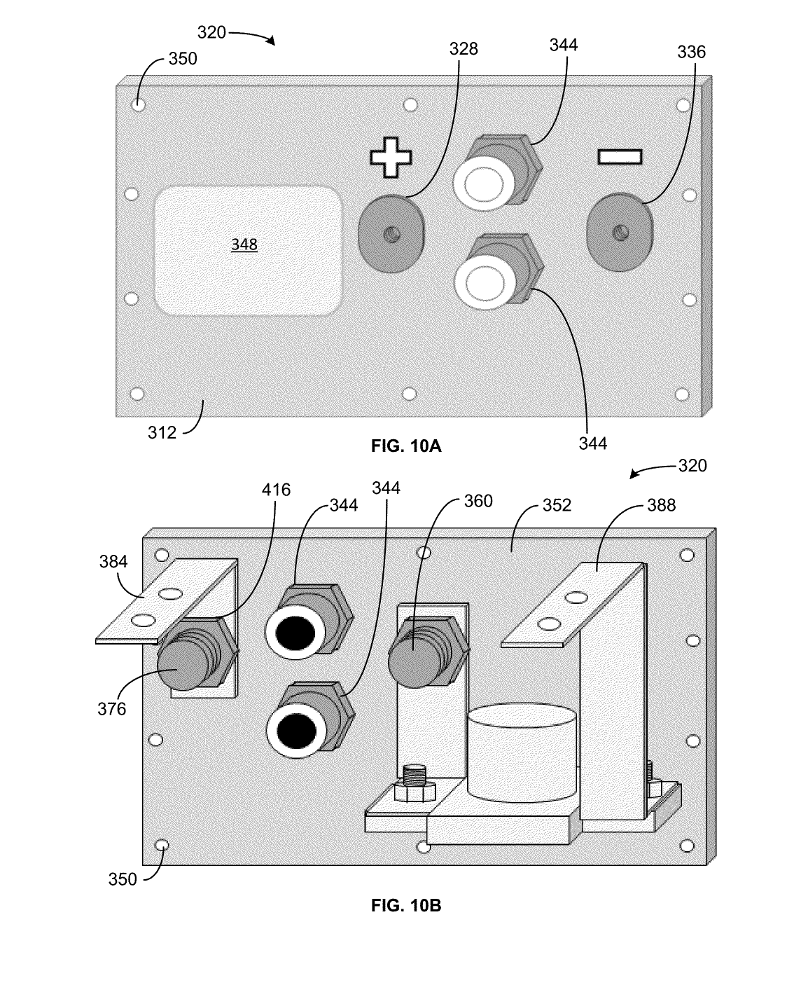

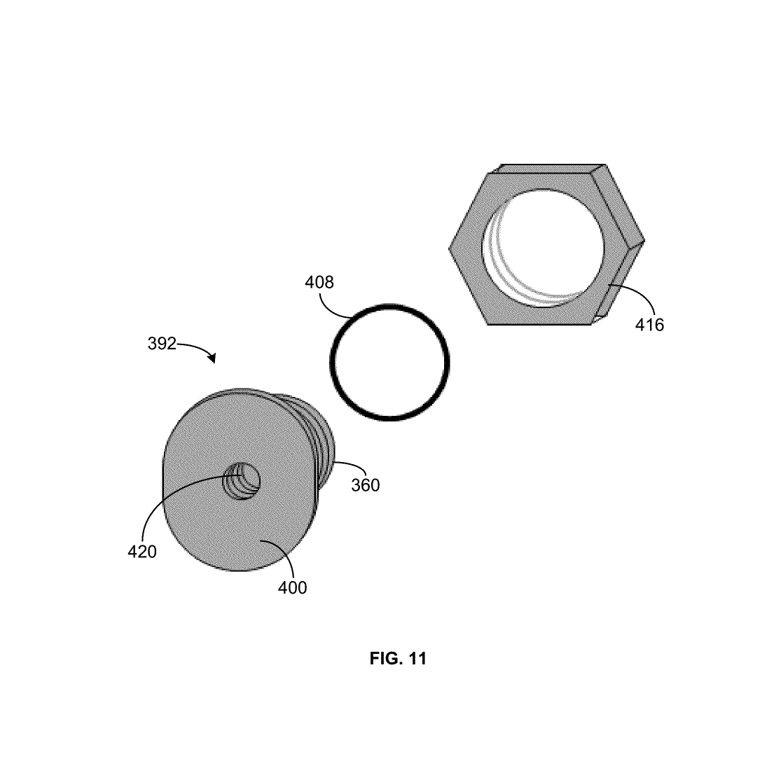

At least a first output cell terminal 168 and a second output cell terminal 176 are left exposed (i.e. non-connected to another terminal). The first output cell terminal 168 and the second output cell terminal 176 can be coupled to respective battery pack terminals that may be constructed, as described below with respect to FIGS. 10A to 11. One of the battery pack terminals may be a positive terminal for a battery pack system and the other battery pack terminal may be a negative terminal for the battery pack system. The battery pack terminals are externally located terminals of the battery pack system that allows the battery pack system to be electrically coupled to an external device, system or power network.

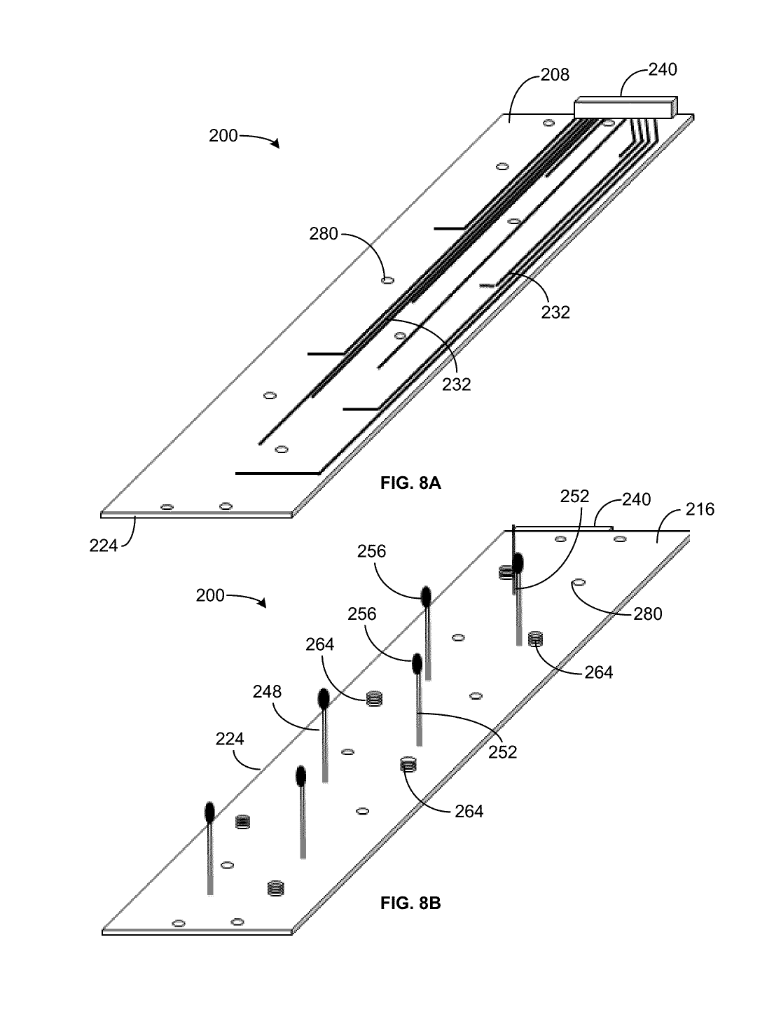

Referring now to FIGS. 8A and 8B simultaneously, therein illustrated are perspective views of the exterior and interior surfaces 208 and 216, respectively, of an example embodiment of a measurement board 200 that may be used in a battery pack system. The measurement board 200 comprises at least one sensor. The at least one sensor may be at least one battery cell tap, and/or at least one thermistor. It will be understood that the interior surface 216 of the measurement board 200 refers to the surface that will be oriented towards the battery cells 2 once placed in a battery pack system. It will be understood that the exterior surface 208 of the measurement board 200 refers to the surface that will be oriented away from the battery cells 2 once placed in a battery pack system.

The measurement board 200 includes a supporting layer 224 having printed circuit traces 232 traced thereon. The printed circuit traces 232 are in signal communication with a signal port 240. For example, the signal port 240 can be coupled via suitable connector, such as a cable, to a battery monitoring system or battery management system board. In some embodiments, the signal port 240 may be releasably connectable with a corresponding port on another board, such as a battery management system board, for example.

The measurement board 200 further includes one or more temperature sensors 248 extending from the interior surface 216. The temperature sensors 248 may include an elongated member 252 and a sensor element 256 positioned at an end of the elongated member 252. Accordingly, the sensor elements 256 are located at a distance away from the interior surface 216 to permit measurement of temperature at a location away from the interior surface 216 and in close proximity to at least one of the battery cells 2. The temperature sensor 248 may be a thermistor. The temperature sensors 248 are in signal communication with the signal port 240 via a portion of the printed circuit traces 232. Temperature readings made by the sensor elements 256 during operation of the battery cells 2 may be communicated to the signal port 240.

The measurement board 200 may further include at least two contacts 264 located on the interior surface 216. The at least two contacts 264 may be used to measure battery voltage and/or current. The at least two contacts 264 are each in signal communication with the signal port 240 via a portion of the printed circuit traces 232. Pairs of the contacts 264 permit measurement of a voltage difference therebetween such as between first and second battery cells that may be coupled to one another using any combination of series and/or parallel connections of any number of battery cells therebetween. According to one example embodiment, the contacts 264 may be resilient members, such as spring members or a bendable cantilevered metal strip.

Referring now to FIGS. 7, 8A and 8B simultaneously, according to at least one example embodiment, the measurement board 200 can be disposed over an exterior surface of one of the first cell carrier 32a and the second cell carrier 32b while measuring one or more properties related to the battery cell sub-assembly 120 during operation. More specifically, the measurement board 200 may be oriented so that its interior surface 216 is oriented towards the battery cells 2 and faces the exterior surface 44 of one of the first cell carrier 32a and the second cell carrier 32b.

Accordingly, the first cell carrier 32a and/or the second cell carrier 32b can be provided with a third set of throughholes 272. The throughholes 272 may be appropriately located according to the location of the upstanding walls 56 and 56b so that they are aligned with the gaps 128 formed between adjacent battery cells 2 of the matrix of battery cells 2. The temperature sensors 248 of the measurement board 200 may be appropriately located according to the locations of the third throughholes 272 of the first cell carrier 32a or second cell carrier 32b to pass therethrough so that the sensor elements 256 are in close proximity to one or more of the battery cells 2.

For example, the sensor element 256 may be positioned amidst the plurality of battery cells 2. More particularly, the sensor element 256 may be positioned within the gaps 128 formed between adjacent battery cells 2. The temperature near at least one of the battery cells 2 can then be measured by the at least one temperature sensor 248 and communicated to an external system, such as battery monitoring system or a battery management system during use. The measurements made by the temperature sensors 248 may be communicated via a portion of the printed circuit traces 232 to the signal port 240 of the measurement board 200.

Where the measurement board 200 further includes at least two contacts 264, the two contacts 264 are appropriately positioned according to a configuration of the electrically conductive interconnecting elements 24 that couple the battery cell terminals 16a and 16b so that a first of the contacts 264 electrically couples with a first of the battery cell terminals 16a and the second of the contacts 264 electrically couples with a second of the battery cell terminals 16b or the same node of 16a or 16b at a different node than the node of the first battery cell terminal 16. A node may be formed of an electrically conductive interconnecting element 24 and the battery cell terminals 16 that are coupled by that element 24. Accordingly, a voltage difference between various battery cell terminals may be measured.

For example, the first resilient contact 264 can electrically couple with any one of one or more battery cell terminals coupled to a first electrically conductive interconnecting element 24. The first resilient contact 264 may also be electrically coupled with the first electrically conductive interconnecting element 24 that couples the one or more battery cell terminals.

Similarly, the second contact 264 can electrically couple to any one of one or more battery cell terminals that are coupled to a second electrically conductive interconnecting element 24. The second resilient contact 264 may also be electrically coupled with the electrically conductive interconnecting element 24 that couples the one or more battery cell terminals.

It will be appreciated that providing the contacts 264 as resilient members better ensures that a proper electrical connection with the battery cell terminals is maintained. For example, vibration or shock forces may cause the measurement board 200 to be displaced away from the exterior surface 44 of the first cell carrier 32a or the second cell carrier 32b. However, where the resilient members are initially compressed, the resilient members can decompress and extend in length due to displacement of the measurement board 200 while still maintaining an electrical connection with the battery cell terminals.

According to at least one embodiment, the supporting layer 224 of the measurement board 200 may include one or more board openings 280 and the first or second cell carrier 32a and 32b may include one or more standoffs 288 extending from the exterior surface 44. The standoffs 288 may cooperate with the board openings 280 to fix the measurement board 200 in place with respect to the first or second cell carrier 32a and 32b, as the case may be. For example, the standoffs 288 may make a friction fit with the board openings 280 to hold the measurement board 200 in place. In other embodiments, appropriate fasteners may also be used, such as screws, to fasten the measurement board 200 to the cell carrier 32a or 32b as the case may be.

The measurement board 200 allows the battery cells 2 to be monitored and controlled on a periodic or continuous basis during operation and charging. Accordingly, the information measured by the sensors of the measurement board 200 may be passed to a battery management system board through the signal port. The battery management system board may be used to control the charge profile and the output of the battery pack system.

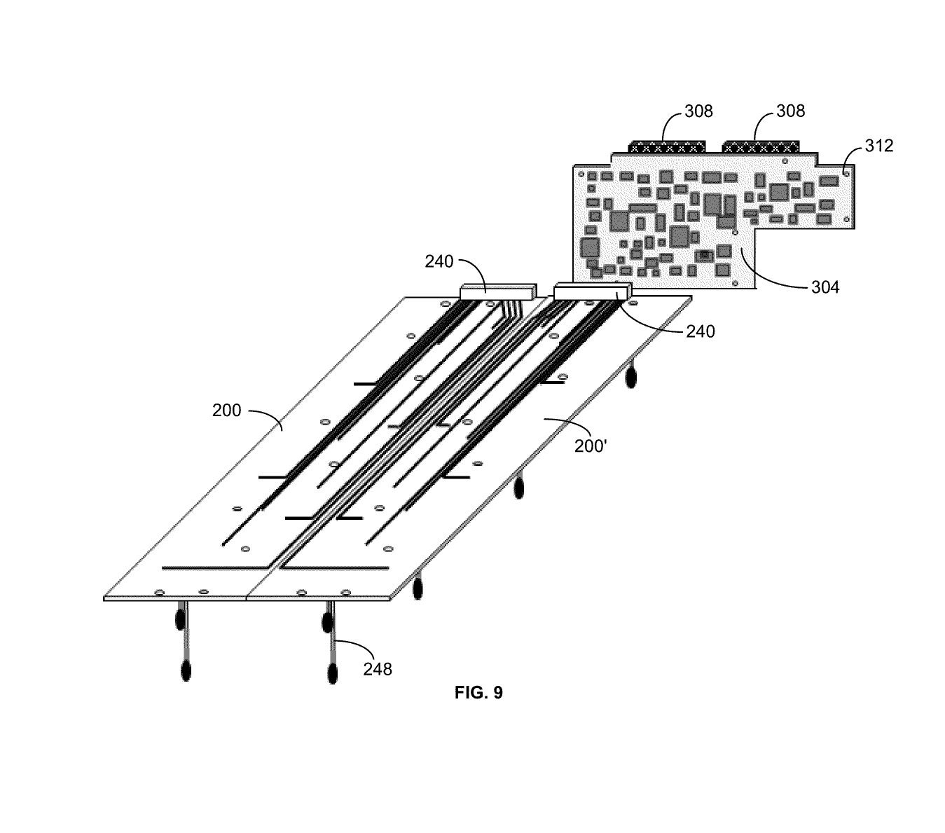

Referring now to FIG. 9, therein illustrated is an exploded view of two measurement boards 200 and 200′ and a battery management system board 304 that provide the battery pack sub-assembly electronics according to one example embodiment and may be used in a battery pack system. The battery measurement boards 200 and 200′ may be arranged in a side by side fashion as shown in FIG. 9, or they may be arranged in another fashion depending on the layout of the battery cells 2. The side-by-side measurement boards 200 and 200′ allows an electrical path to be easily formed for passing a DC current, which may be used to power the sensors. A first portion of the electrical path can extend from a first end to a second end opposite the first end of a first measurement board 200. A second portion of the electrical path can extend from a second end of a second measurement board 200′ to a first end opposite the second end. The second ends of the first and second measurement boards 200 and 200′ may be located proximate to each other and the first and second portions may be interconnected at the respective second ends. Positive and negative terminals of the electrical path can be located at the respective first ends of the first and second measurement boards 200 and 200′.

The battery management system board 304 includes signal ports 308 for connection with the signal ports 240 of the measurement boards 200 and 200′. The battery management system board 304 may also have mounting provisions 312 which allow for mounting to the battery cell sub-assembly, possibly through corresponding mounting provisions 104 on one of the end plates 96.

The battery management system board 304 can receive temperature readings made by the at least one temperature sensor 248 and the voltage readings made by the contacts 264 of the measurement boards 200 and 200′. The battery management system board 304 can further have ports for connection with an external battery management system or an external battery monitoring system.

The battery management system 304 may provide various functions such as, but not limited to, at least one of battery cell block balancing, and cell charge control. The battery management system may also provide a safety system which can control the output power through a high power contactor (not shown). The battery management system 304 may be implemented using hardware, software, or mixture thereof according to methods known in the art.

Referring now to FIG. 10A, therein illustrated is a front view of an exterior surface 312 of an example embodiment of an enclosure end plate 320 (e.g. a rear end plate) that may be used as part of the enclosure of a battery pack system. The enclosure end plate 320 provides a power and data interface for the battery pack system. The enclosure end plate 320 may be made from a non-electrically conducting material such as a plastic or a composite, for example. The enclosure end plate may be placed at the rear end of a battery pack system.

A first pack terminal 328, which may be a positive terminal, and a second pack terminal 336, which may be a negative terminal are mounted on the enclosure end plate 320. The pack terminals 328 and 336 may be external power terminals for a battery pack system. The first pack terminal 328 and the second pack terminal 336 may each permit coupling an electrical lead thereto. The leads that are coupled to the first pack terminal 328 and the second pack terminal 336 may then be used to couple the battery pack system to an external device, such as another battery pack system, an electrical device to which the battery pack supplies electrical energy or a power network or other system. The electrical lead may be coupled to the first pack terminal 328 and the second pack terminal 336 via screw connections, for example.

At least one battery management port 344 may also be mounted on the enclosure end plate 320 for providing a data connection with an external battery management system or battery monitoring system. The data management port 344 may be used to provide real time information regarding the battery pack system during operation and charging.

In some embodiments, an area 348 may be included on the surface 312 of the enclosure plate 320 for displaying vendor/operational information for the battery pack system.

Mounting provisions 350 for the enclosure end plate 320 are used to mount the enclosure end plate 320 at an end of the enclosure for the battery pack system.

It should be understood that while the battery management port 344 and the first and second pack terminals 328 and 336 are shown located on an exterior surface 312 of an end plate of a battery pack system, the battery management ports 344 and the pack terminals 328 and 336 may be at any other location on an exterior of the battery pack system to permit connection to an external device.

Referring now to FIG. 10B, therein illustrated is a rear view of an interior surface 352 of the enclosure plate 320 of the enclosure of the battery pack. A threaded portion 360 of the first pack terminal 328 is located on the interior surface 352 of the enclosure plate 320. A first output bus bar 388 is electrically coupled to a threaded portion 360 of the first pack terminal 328. Furthermore, a threaded portion 376 of the second pack terminal 336 is located on the interior surface 352 of the enclosure plate 320. A second output bus bar 384 is electrically coupled to the threaded portion 376 of the second pack terminal 336. The output bus bars 384 and 388 act as the main power output electrical contactors (e.g. busses) for the battery pack system which couple the battery pack sub-assembly to the outside of the battery pack system.

Referring now to FIG. 11, therein illustrated is a perspective exploded view of parts of an example embodiment of a power pack terminal that may be used in a battery pack system. The power pack terminal may be the first pack terminal 328 or the second pack terminal 336. The power pack terminal shown may be made from copper, aluminum or any other electrical conducting material. For example purposes, the power pack terminal will be described with reference to the first pack terminal 328, but it will be understood that the description may also be applicable to the second pack terminal 336.

The pack terminal 328 includes an electrically conductive member 392 having the threaded portion 360 and a flanged portion 400 having a non-circular shape. The flanged portion 400 (i.e. head portion) is machined on each side to provide indexing or keying to the enclosure end plate 320. The threaded portion 360 is inserted into a first opening of the enclosure plate 320 from the exterior surface 312 so that the threaded portion 360 is positioned on the interior surface 352. It will be understood that when the enclosure of the battery pack system is closed, the threaded portion 360 will be located in an interior of the enclosure. A non-circular recess is formed about the first opening and the flanged portion 400 is positioned to be snugly received within the non-circular recess.

An o-ring 408 is fitted over the threaded portion 360 so as to seal the opening of the enclosure plate 320. The o-ring 408 may be slot machined or molded onto the back side of the enclosure end plate 320 to ensure a water tight seal between the power terminal and the enclosure end plate 320.

The first output bus bar 388 may be fitted over the threaded portion 360 so as to form an electrical coupling with the threaded portion 360. The first output bus bar 388 is positioned on the interior surface 352 of the enclosure plate 320.

A nut 416 is screwed over the threaded portion 360 to secure the o-ring 408 and the first output bus bar 388. The nut may be made of the same material as the electrically conductive member 392. Due to the non-circular shape of the flanged portion 400 and the corresponding non-circular shape of the recess on the exterior surface 312 of the enclosure plate 320, a rotational force applied on the electrically conductive member 328 from the screwing of the nut 416 does not cause the electrically conductive member 328 to be rotated. Accordingly, the nut 416 can tightly secure the output bus bar 388 to the threaded portion 360.

The electrically conductive member 392 may have formed therein an internally threaded recess 420 extending inwardly from the flanged portion 420. The internally threaded recess 420 permits coupling of a lead thereto, which may be further coupled to an external device, such as another battery pack system or an electrical device to which the battery pack system supplies electrical energy.

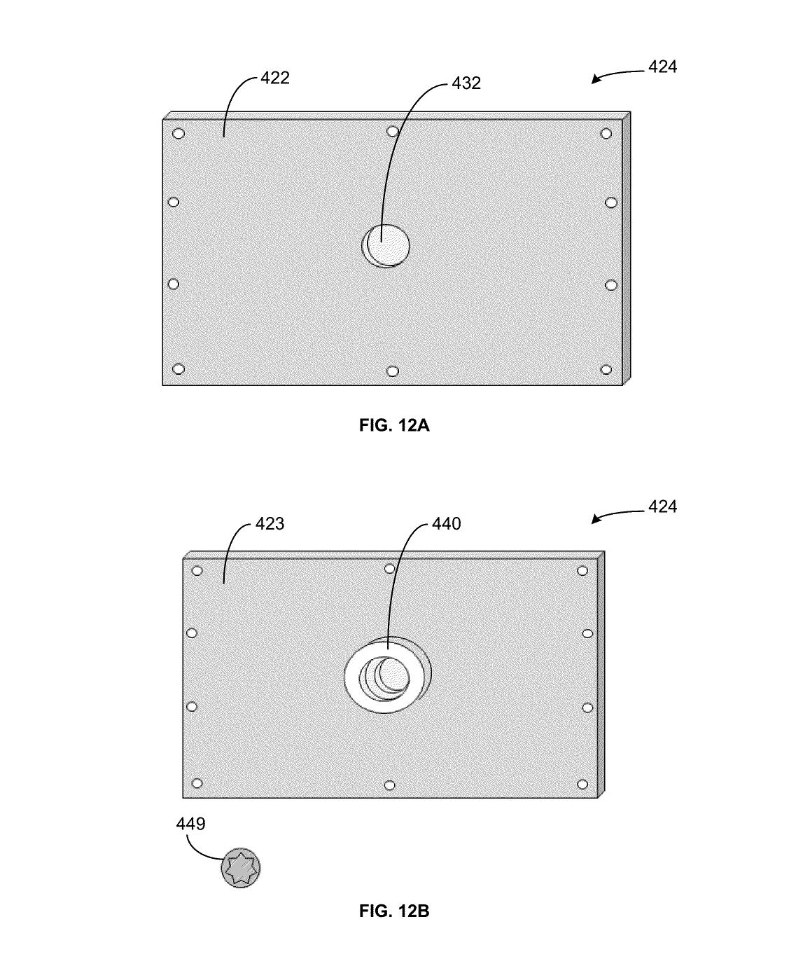

Referring now to FIGS. 12A and 12B simultaneously, therein illustrated is a perspective view of an exterior surface 422 and an interior surface 423, respectively, of an enclosure end plate 424 according to an example embodiment. For example, the enclosure end plate 424 may be a front end plate that is positioned opposite the enclosure plate 320 of FIGS. 10A and 10B. The enclosure end plate 424 may be made from aluminum or other materials such as plastics or composites.

The enclosure end plate 424 has formed therein an opening 432. An annular member 440 is positioned about the opening 432 on the interior surface 423. Furthermore, a burst disk 449 is mounted over the annular member 440, by using a fastener such as glue or another adhesive, so as to seal the opening 432. The burst disk 449 is configured to break when the internal pressure inside the enclosure of the battery pack system exceeds a predetermined pressure limit. The pressure limit may be set according to predetermined manufacturer's requirements related to at least one of the type, number and power rating of the battery cells 2, for example.

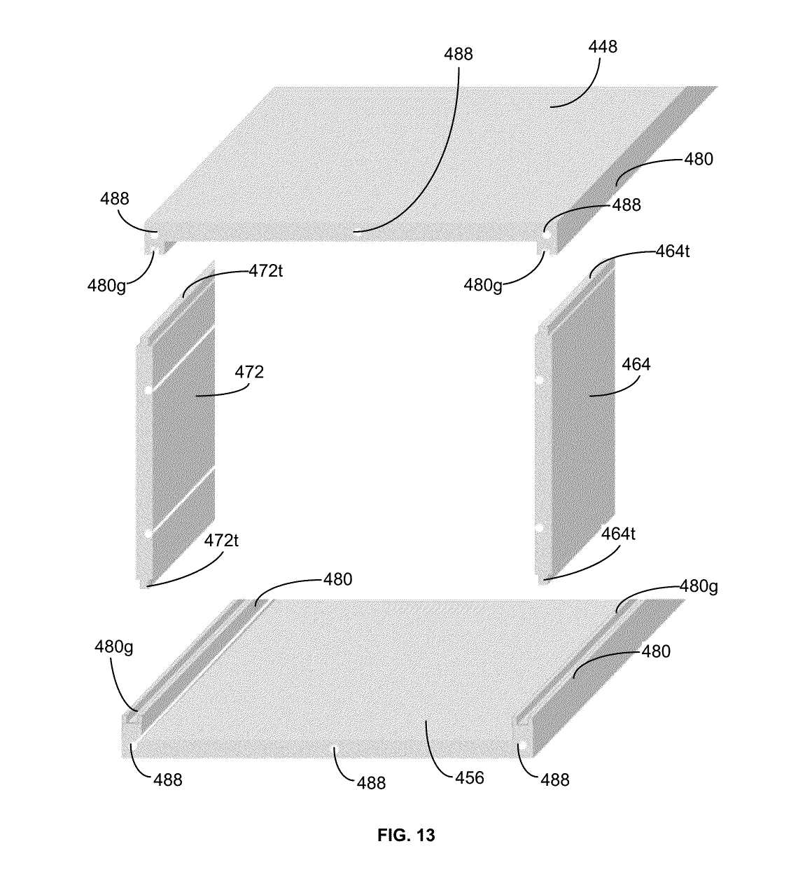

Referring now to FIG. 13, therein illustrated is an exploded view of longitudinal walls 448, 456, 464, and 472 which form the outer walls of an enclosure of the battery pack system according to an example embodiment. The top and bottom longitudinal walls 448 and 456 each include a planar portion and transversely extending portions 480 running along the length of the longitudinal walls 448 and 456. The edges of the transversely extending portions 480 have a channel or groove 480g. The end of the top longitudinal wall 448 and bottom longitudinal wall 456 further includes mounting provisions 488, which may be recesses. The top longitudinal wall 448 and the bottom longitudinal wall 456 may have substantially the same shape.

The first and second side walls 464 and 472 each have a planar body. The edges of the side walls 464 and 472 each include a rib or a tongue 464t and 472t, respectively, which co-operate with the grooves of the transversely extending portions 480 of the top and bottom longitudinal walls 448 and 456. For example, and as illustrated in FIG. 13, the edges of the side walls 464 and 472 are tongues and the edges of the transversely extending portions 480 are grooves that cooperate with the tongues 464t and 472 in a friction fit or locking manner. For example, the tongues 464t and 472t of the side walls 464 and 472 may be inserted into the grooves 480g of the top and bottom walls 448 and 456. The side walls 464 and 472 may be further bonded with the top and bottom walls 448 and 456 using a suitable bonding substance, such as epoxy.

The top wall 448 and the bottom wall 456 may be formed by extrusion of material through a suitable mold. The extruded material can be aluminum, as well as other metals or materials such as plastics or composites, for example. According to at least one embodiment, the top wall 448 and the bottom wall 456 may be identical. Similarly, the side walls 464 and 472 may be formed by extrusion of material through a suitable mold. The extruded material may also be aluminum, as well as other metals or materials such as plastics or composites, for example. According to at least one example embodiment, the side walls 464 and 472 may be identical. All mounting provisions for the front and rear end plates 424 and 320, respectively, may also be created during the extruding process. This makes for low cost parts that can be used in several places without modification.

The forming of the walls 448, 456, 464, and 472 of the enclosure by extrusion provides flexibility and modularity. For example, where different numbers of battery cells 2 are to be used in fabricating various battery packs, the length of the walls 448, 456, 464 and 472 formed by extrusion can be easily adjusted so as to accommodate the different number of battery cells 2. For example, where different battery cells having different widths or heights are used, the width of either the top and the bottom walls 448 and 456 and/or the side walls 464 and 472 can be easily adjusted to accommodate the different types of battery cells.

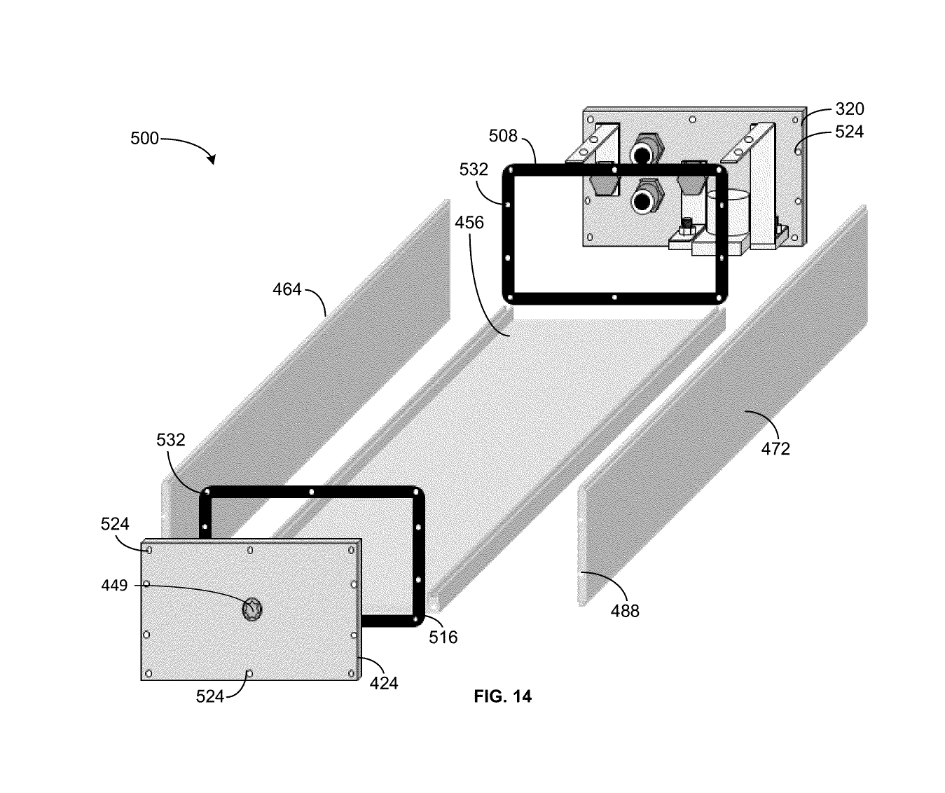

Referring now to FIG. 14, therein illustrated is an exploded view of walls of an enclosure 500 and other battery cell enclosure assembly components that may be used in a battery pack system according to an example embodiment. The rear end plate 320 is positioned at first end of the longitudinal walls 456, 464, and 472 (top wall 448 is not shown for ease of illustration). To help seal this end of the enclosure, a first sealing gasket 508 may be positioned between the inner surface 352 of the end plate 320 and the first end of the longitudinal walls 456, 464, and 472.

The front end plate 424 is positioned at a second end of the longitudinal walls 456, 464, and 472. To help seal this end of the enclosure, a second sealing gasket 516 may be positioned between the interior surface 423 of the front end plate 242. For example, the second sealing gasket 516 can be positioned between the inner surface 423 of the end plate 320 and the second end of the longitudinal walls 456, 464 and 472.

The rear end plate 320 and the front end plate 424 can each have formed therein a plurality of openings 524 which are aligned with mounting provisions 488 of the longitudinal walls 456, 464, and 472. The sealing gasket 508 may further have formed therein corresponding openings 532 that are aligned with the openings 524 and mounting provisions 488. Suitable fasteners extending through the openings 524 and 532 and into the mounting provisions 488 may be used to secure the front end plate 320 and the rear end plate 424 to the longitudinal walls 456, 464, and 472. The attachment of the rear end plate 320, the front end plate 424, and the longitudinal walls 448, 456, 464 and 472 form an enclosure of the battery pack system within which the battery pack cell sub-assembly 120 may be housed. The components may be bonded together during the final assembly.

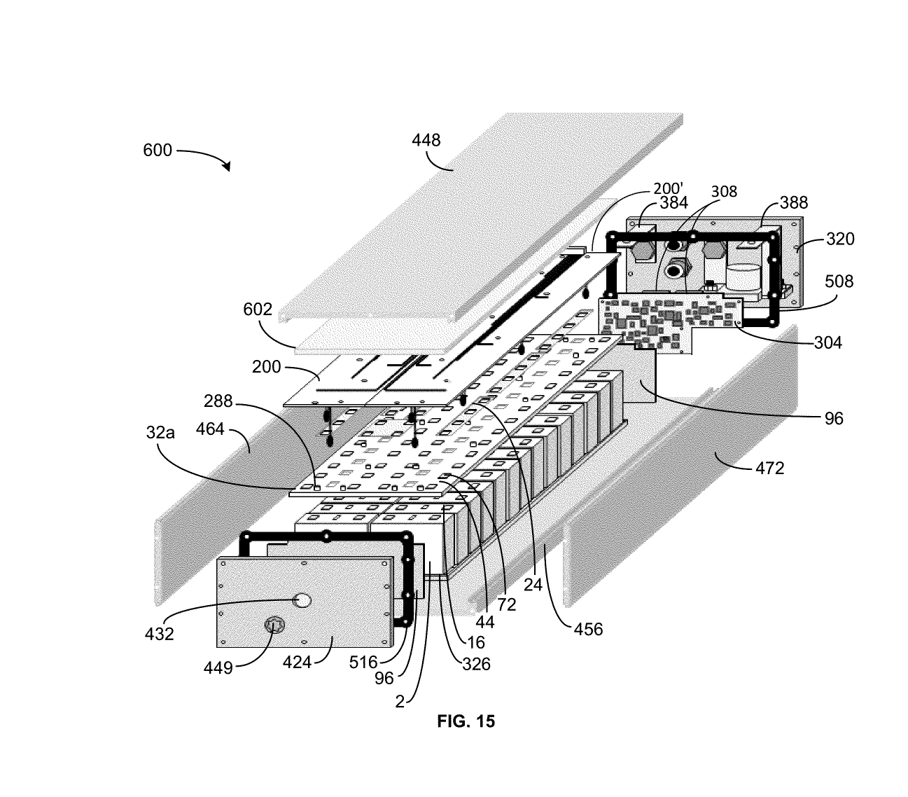

Referring now to FIG. 15, therein illustrated is a perspective exploded view of a battery pack system 600 according to an example embodiment. According to a method for fabricating the battery pack system 600, a first cell carrier 32a, a second carrier 32b and plurality of battery cells 2 are provided. The battery cells 2 are placed within the first cell carrier 32a and the second cell carrier 32b so as to be disposed therebetween. Consequently, the first cell carrier 32a is positioned over the first ends of the plurality of battery cells and the second cell carrier 32b is positioned over the second ends of the plurality of battery cells 2.

At least one of the first cell carrier 32a and the second cell carrier 32b is a retaining cell carrier and the battery cells 2 are positioned within the matrix of recesses 64 of the retaining cell carrier so as to be retained fixedly therein. For example, one battery cell 2 may be retained per recess 64 of the matrix of recesses of the retaining cell carrier.

At least one of the first cell carrier 32a and the second cell carrier 32b is a perforated cell carrier. When this perforated cell carrier is positioned over the ends of the battery cells 2 having the plurality of cell terminals 16a and 16b, these cell terminals extend through terminal openings 72 of the perforated cell carrier.

Sub-assembly end plates 96 may then be positioned at the ends of the first cell carrier 32a and the second cell carrier 32b.

A retaining member 136 may then be provided to hold together the first cell carrier 32a, the second cell carrier 32b and the plurality of battery cells 2 therebetween. For example, the retaining member 136 may be a strap that extends about the first cell carrier 32a, the second cell carrier 32b and the plurality of cell terminals.

The fabrication method further includes coupling a plurality of electrically conductive interconnecting elements 24 to some of the battery cell terminals 16a and 16b that extend through the perforated cell carrier. The plurality of electrically conductive interconnecting elements 24 couple the battery cell terminals 16 according to a desired configuration (e.g. series and/or parallel connection).

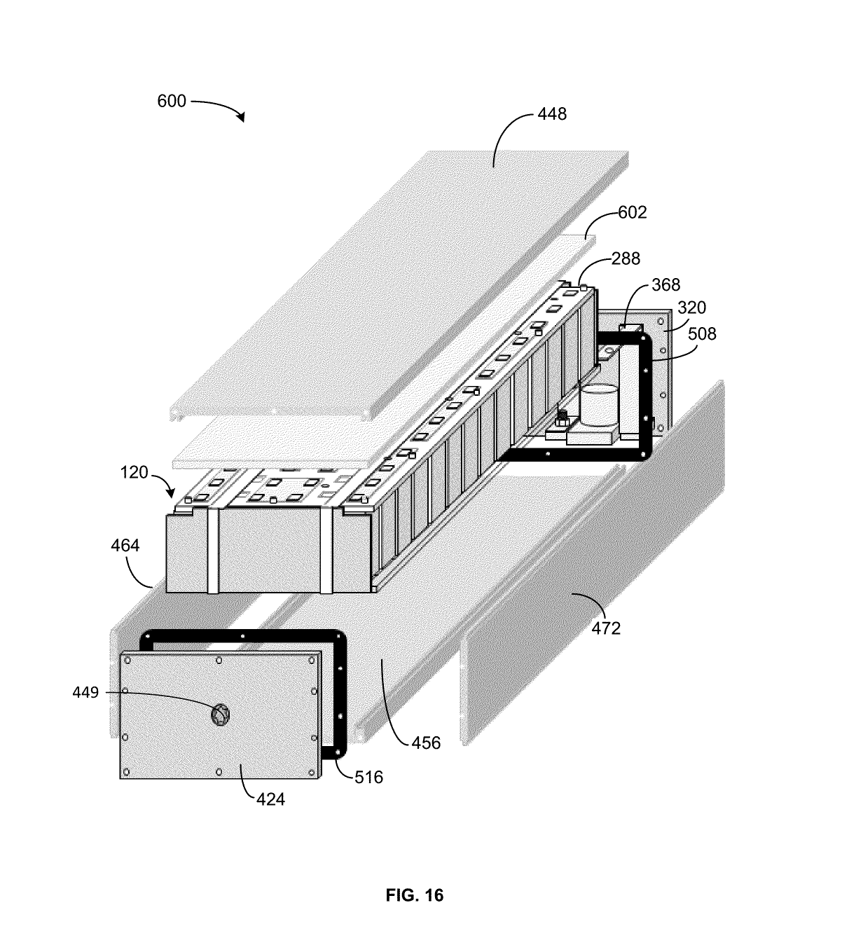

Referring now to FIG. 16, therein illustrated is a perspective view of the battery pack 600 in an intermediate state during its fabrication in which the battery cell sub-assembly 120 has been fully assembled and no battery pack electronics are shown. However, it should be understood that one or more measurement boards 200 having sensors such as temperature sensors 248 can be positioned over the exterior surface 44 of one of the first cell carrier 32a and the second cell carrier 32b. The measurement boards 200 may be appropriately positioned so that the temperature sensors 248 extend through third throughholes 272 of the cell carriers and are positioned near the battery cells 2.

Where the measurement boards 200 further include contacts 264, the measurement boards 200 may be appropriately positioned so that a first of the contacts 264 electrically contacts a first of the battery cell terminals and a second of the contacts 264 electrically contacts a second of the battery cell terminals that does not share a node with the first of the battery cell terminals. The contacts 264 may be used to measure voltage and/or current.

The method may further include fastening the measurement boards 200 to the cell carrier 32 via standoffs 288 on the exterior surface 44 and board openings 280 on the measurement boards.

The method may further include coupling the measurement boards 200 to a battery management board 304.

The fabrication method further includes providing an enclosure end plate 320 as described herein according various examples. A first output bus bar 388 of the enclosure end plate 320 is electrically coupled to a first pack terminal 328 and to a first battery cell terminal 168 from the plurality of battery cells 2. Accordingly, an electrical path is formed between the first pack terminal 328 of the battery pack system 600 and the interconnected battery cells 2 via the first output bus bar 368 and the first output cell terminal 168. Similarly, a second output bus bar 384 is electrically coupled to a second output battery cell terminal 176 from the plurality of battery cells 2. Accordingly, an electrical path is formed between the second pack terminal 336 of the battery pack system 600 and the interconnected battery cells 2 via the second output bus bar 384 and the second output cell terminal 176.

When a battery management board 304 is to be included in the battery pack system 600, the method of fabrication may further include connecting an output port of the battery management board 304 with at least one battery management port 344 of the battery pack system 600.

The fabrication method further includes enclosing the plurality of battery cells within a sealed enclosure for the battery pack system. For example, and as illustrated in FIG. 16, longitudinal walls 448, 456, 464 and 472 and front and rear end plates 424, 320 are attached together. In at least some embodiments, one or more closed cell foam layers 602 can be placed between an interior surface of one of the longitudinal walls or end plates and the battery cell sub-assembly 120 before the longitudinal walls 448, 456, 464 and 472 and the front and rear end pates 424 and 320 are secured together. The foam layers 602 may be used to dampen vibrations that travel from the exterior of the battery pack system to the internal components, such as the battery cells 2. The foam layers 602 may also be used to compensate for manufacturing tolerances.

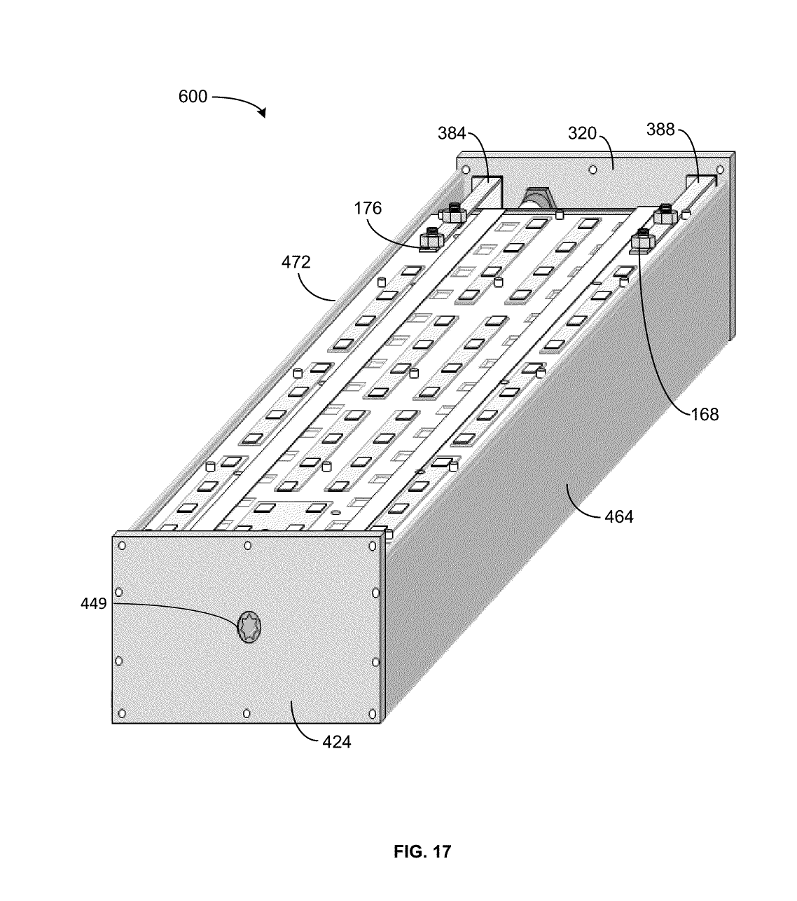

Referring now to FIG. 17, therein illustrated is a perspective view of a partially assembled battery pack 600 according to an example embodiment with bus bar connections to external connectors. As illustrated, the bottom wall 456, the first and second side walls 464 and 472 and the front and rear end plates 424 and 320 have been secured together. Furthermore, the first output bus bar 368 is electrically coupled to two first output cell terminals 168 and the second output bus bar 384 is electrically connected to two second output cells terminals 176. For example, and as illustrated in FIG. 17, the first and second output bus bars 368, 384 are respectively connected to first and second output cell terminals 168, 176 using a nut and bolt connection. However, it will be understood that any other suitable connections may be used, such as welding or laser welding. The output bus bars may be coupled first, and then the other bus bars may be coupled.

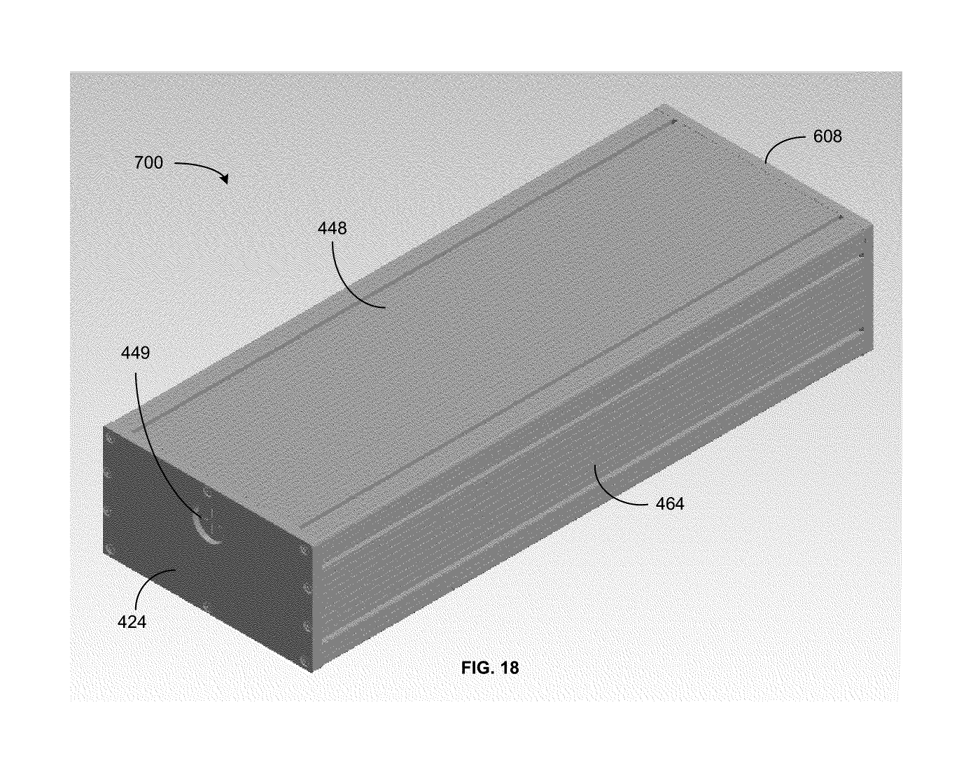

Referring now to FIG. 18, therein illustrated is a perspective view of a fully assembled battery pack system 700 according to an example embodiment. The battery cell sub-assembly 120 is completely enclosed within the enclosure 608 formed of the enclosure walls 448, 456, 464 and 472 as well as the front and rear end plates 424 and 320.

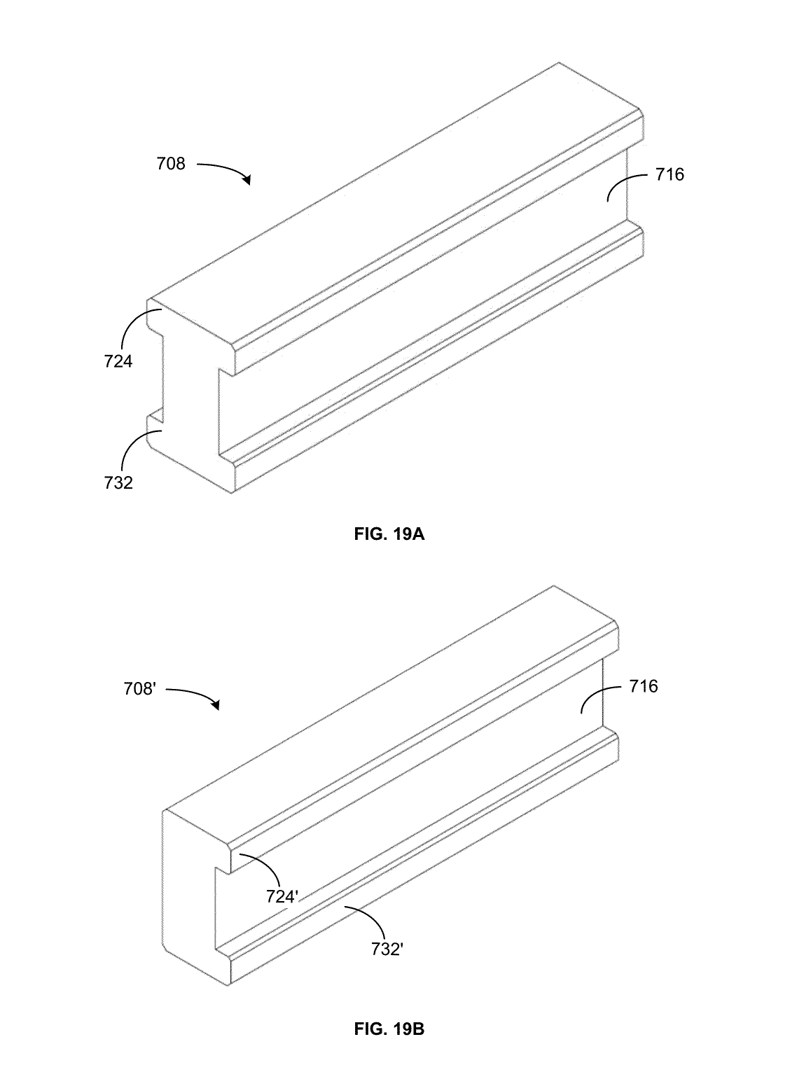

Referring now to FIG. 19A, therein illustrated is a perspective view of a pack connector 708 according to one example embodiment. The pack connector 708 includes an elongated web 716, a first elongated flange 724 extending outwardly at a first end of the elongated web 716 and a second elongated flange 732 extending outwardly at a second end of the elongated web 716 opposite the first end. The pack connector 708 is operable to mechanically interconnect walls of two adjacent battery pack systems 700. It will be appreciated that pack connector 708 resembles an I-beam.

Referring now to FIG. 19B, therein illustrated is a perspective view of a pack connector 708′ according to an alternative example embodiment. The pack connector 708 includes the elongated web 716, a first elongated flange 724′ extending outwardly at a first end of the elongated web 716 and a second elongated flange 732′ extending outwardly at a second end of the elongated web 716 generally opposite the first end. Whereas the elongated flanges 724 and 732 of pack connector 708 extend from both sides of the elongated web 716, the elongated flanges 724′ and 732′ of the alternative example embodiment only extend from one side of the elongated web 716. It will be appreciated that the alternative pack connector 708′ resembles a C-beam.

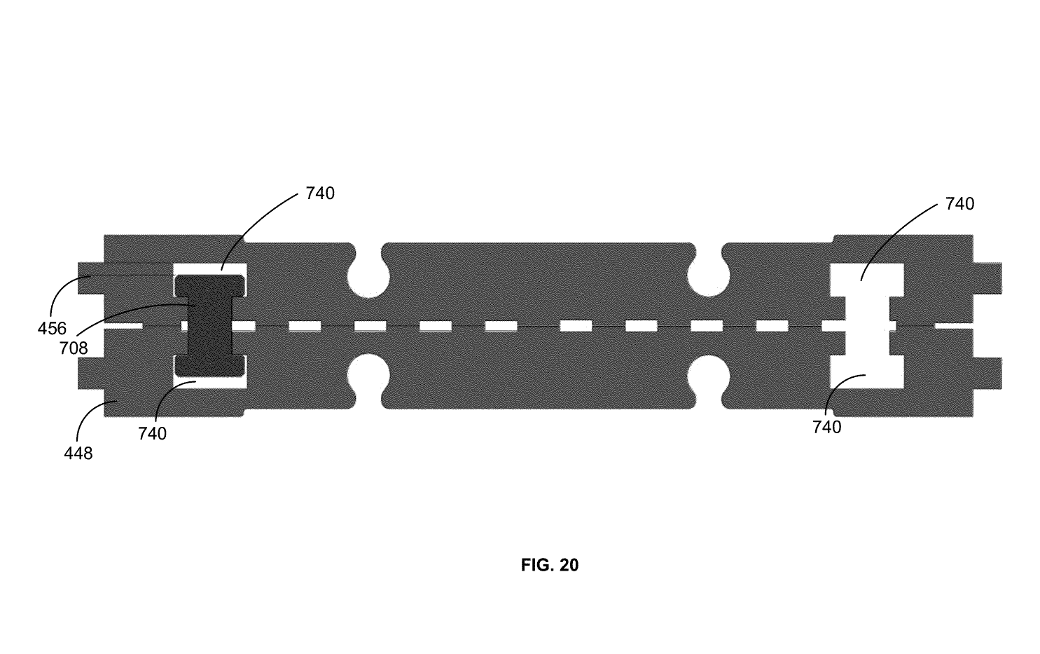

Referring now to FIG. 20, therein illustrated is a front elevation view of two enclosure walls being interconnected by a pack connector 708. For example purposes, a top longitudinal wall 448 of a first battery pack system 700 and bottom longitudinal wall 456 of a second battery pack system 700 are illustrated but it will be understood that the example is also applicable to sidewalls 464 and 472, for example. According to this example embodiment, each of the walls 448 and 456 have formed therein one or more connecting grooves 740 extending along the length of the wall 448 and having a cross section in the shape of a “T” so that a composite connecting groove having an “I” shape may be formed when the two walls 448 and 472 are adjacent one another. According to an alternative example embodiment, the one or more connecting grooves may each have a cross section in the shape of an “L” so that a composite connecting groove having an “C” shape may be formed when the two walls 448 and 472 are adjacent one another.

When assembling battery packs together, a pack connector 708 is simultaneously inserted into a connecting groove 740 of the top longitudinal wall 448 and a corresponding connecting groove 740 of the bottom longitudinal wall 456. The first flange 724 grips the inner walls of the groove 740 of the bottom longitudinal wall 456 and the second flange 732 grips the inner walls of the groove 740 of the top longitudinal wall 448 thereby mechanically retaining the two walls 448 and 456 together. The connecting grooves 740 may be formed when fabricating the walls 448 and 456 by extrusion.

There may be some embodiments where only one connecting groove may be used for certain side walls of the battery packs if the pack connectors are large enough to provide sufficient mechanical stability when coupling two battery packs together. In other embodiments, at least two connecting grooves and pack connectors may be used for certain sidewalls of the battery packs.

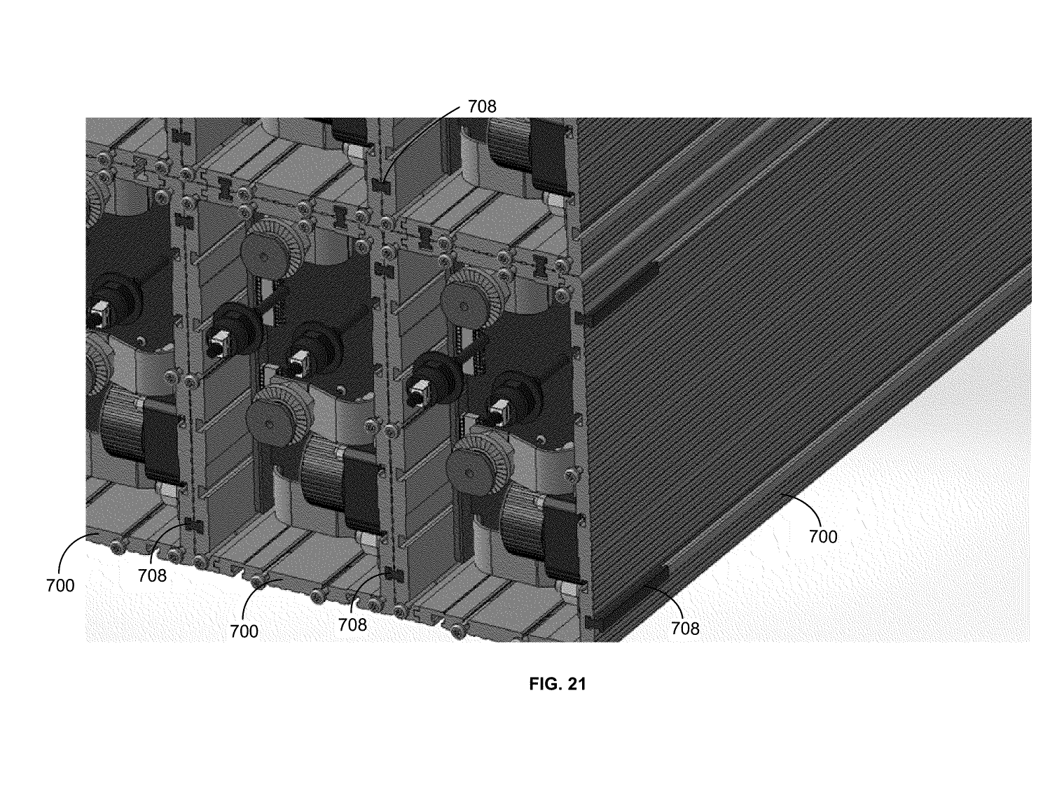

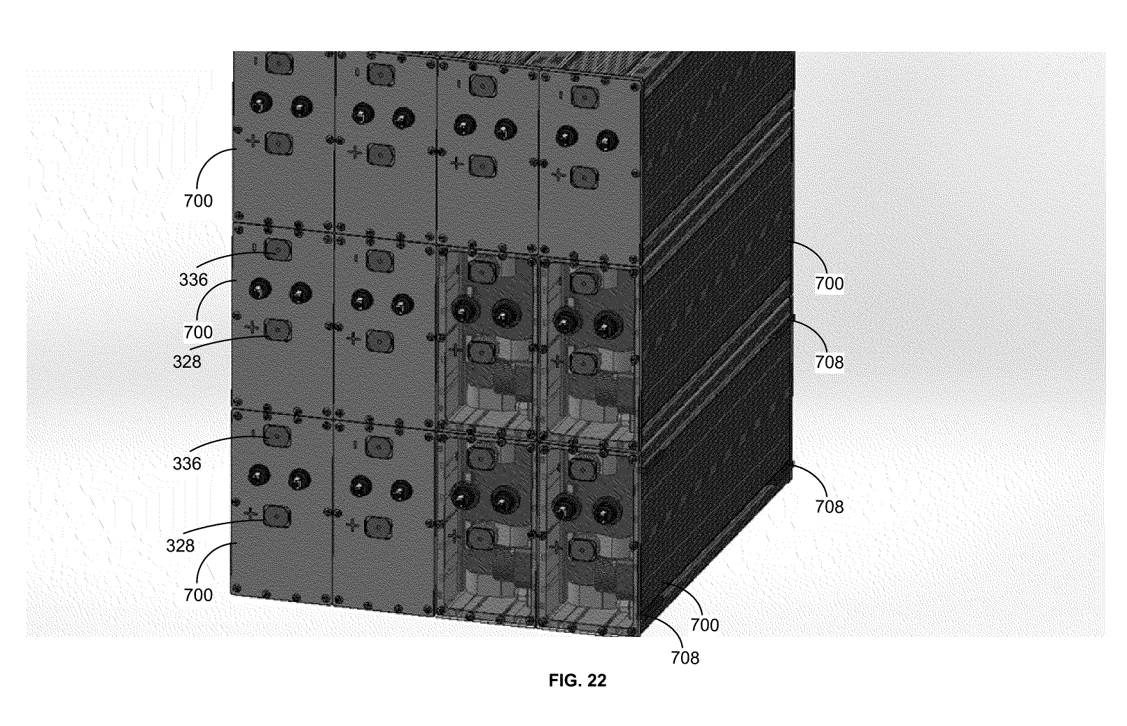

Referring now to FIG. 21, therein illustrated is a perspective view of a plurality of interconnected assembled battery pack systems 700 being interconnected to one another using pack connectors. For example purposes, the end plates 320 have been removed to show the positioning of the connectors 708. For example purposes, “I” shaped connectors 708 are illustrated but it will be understood that “C” shaped connectors 708′ and corresponding L-shaped grooves may be used. As illustrated, a plurality of pack connectors 708 have each been inserted into respective grooves of pairs of adjacent enclosure walls 448, 456, 464 or 472, thereby mechanically retaining the battery pack systems 700 together. The pack connectors 708 may be retained within the respective grooves via press fit. Alternatively, the pack connectors 708 may be retained within the respective grooves via using an adhesive.

While the example illustrated in FIG. 22 shows two pack connectors 708 being provided for each enclosure wall. Alternatively, one or more than two pack connectors 708 may be used on each wall for interconnecting assembled battery pack systems 700. For example, one, three, four or more pack connectors 708 may be used for interconnecting two adjacent enclosure walls as long as they are sized and disposed such that collectively they provide sufficient mechanical stability when coupling two battery packs together.

Referring now to FIG. 22, therein illustrated is a perspective view of a plurality of interconnected assembled battery pack systems 700 wherein some of the battery pack systems 700 have an attached end plate 320 and other battery pack systems 700 have the end plate 320 removed. It will be appreciated that mechanically interconnecting the battery pack systems 700 facilitates the use of multiple battery pack systems 700 together and allows flexibility in meeting the power requirement (i.e. supply voltage and supply current) of different applications, for example, by flexibly interconnecting pack terminals 328, 336 using electrical leads of various battery pack systems in a series or parallel combination.

It should be noted that the basic features of the embodiments described in accordance with the teachings herein may allow for the reduction of costs and ease of manufacturing by utilizing both low cost material extrusion and injection processes as well as using the same parts for different functions or locations (e.g. the upper and lower cell carriers, the end plates of the battery sub-assembly, similar enclosure walls).

It should also be noted that the battery pack system enclosure described in accordance with the teachings herein may also utilize similar extruded and injected modules (e.g. walls) in several areas of the enclosure housing to also reduce complexity, inventory and complication during assembly.

In addition, according to the various teachings herein, control and measurement electronics may be tightly integrated into the battery pack system for a final sealed energy solution which can be used as a module and can be configured with other battery packs to meet or exceed voltage and current requirements of certain applications. Furthermore, individual battery pack systems can be scaled to the voltage and current required in either standalone operation or as one or several modules for larger systems.

### Example 1

According to one example based on the teachings herein, a fully assembled battery pack system may include about twenty-two (22) battery cells 2 arranged in an 11 series by 2 parallel configuration. Each cell may be a 20Ah Lithium Titanate cell and may have a charge voltage of 2.67 VDC/cell, a nominal voltage of 2.3 VDC/cell, and a cut-off voltage of 1.82 VDC/cell.

The 22 battery cells 2 are enclosed within an enclosure 608 having dimensions of about 11 inches long, about 10 inches wide and about 5.25 inches high. The fully assembled battery pack system weighs about 70 lbs and has an operating temperature of about −20° C. to about 55° C. The enclosure is formed of a mixture of aluminum and plastic.

The example fully assembled battery pack system may have a charge voltage of about 29.4 VDC, a nominal voltage of about 25.3 VDC and a cut-off voltage of about 20.0 VDC. The example battery pack system may operate at a maximum continuous discharge of 120 A and 3 C, at a maximum pulse 8 second discharge of 200 A and 5 C, and a max charge current of 120 A and 3 C.

The example fully assembled battery pack system may further perform 12,000 charges at 100% DOD cycles (3 C charge & discharge at 23° C.).

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants, modifications and equivalents may be made without departing from the scope of the invention as defined in the claims appended hereto.

1. A battery pack assembly comprising:
a first cell carrier;
a second cell carrier, at least one of the first cell carrier and the second cell carrier being a retaining cell carrier and having a plurality of upstanding walls extending from a bottom wall thereof and defining a matrix of recesses and at least one of the first cell carrier and the second cell carrier being a perforated cell carrier and having a wall with a plurality of openings;
a plurality of battery cells each having a plurality of cell terminals, the battery cells being retained within the matrix of recesses of the at least one retaining cell carrier and at least a subset of the plurality of cell terminals extending through the openings of the bottom wall of the at least one perforated cell carrier; and
a plurality of electrically conductive interconnecting members each being electrically coupled to at least two of the cell terminals of the plurality of battery cells extending through the openings of the at least one perforated cell carrier and providing an electrical interconnection therebetween.

2. The battery pack assembly of claim 1, wherein the matrix of recesses are arranged to retain adjacent battery cells spaced apart from one another to allow for heat dissipation and reducing short circuiting between the adjacent battery cells.

3. The battery pack assembly of claim 1, wherein the first cell carrier is a retaining cell carrier and the second cell carrier is a retaining cell carrier.

4. The battery pack assembly of claim 3, wherein the first cell carrier retains a first end region of the plurality of battery cells and the second cell carrier retains a second end region of the plurality of battery cells; and the recesses of the first cell carrier are aligned with corresponding recesses of the second cell carrier.

5. The battery pack assembly of claim 1, wherein the perforated cell carrier is also a retaining cell carrier.

6. The battery pack assembly of claim 1, wherein a first subset of the cell terminals of the plurality of battery cells are located at a first end of the battery cells and a second subset of the cell terminals of the plurality of battery cells are located at a second end of the battery cells, the first and second cell carriers are perforated cell carriers, and the first subset of the cell terminals extend through the openings of the first perforated cell carrier and the second subset of the cell terminals extend through the openings of the second perforated cell carrier.

7. The battery pack assembly of claim 1, wherein the at least one perforated cell carrier further comprises a plurality of rupture openings that are configured to permit passage therethrough of material released from a pressure release burst disc of a corresponding battery cell if the corresponding battery cell has a pressure rupture during use.

8. The battery pack assembly of claim 1, further comprising a retaining member for releasably holding together the first cell carrier, the second cell carrier, and the plurality of battery cells therebetween.

9. The battery pack assembly of claim 1, wherein at least one of the electrically conductive interconnecting elements comprise bus bars that are coupled to the at least two cell terminals of the battery cells being interconnected by the bus bars.

10. The battery pack assembly of claim 1, wherein at least one of the first and second cell carriers is formed of polyoxymethylene.

11. The battery pack assembly of claim 1, further comprising at least one measurement board including:
a supporting layer having printed circuit traces thereon;
a signal port coupled to the printed circuit traces; and
at least one sensor for sensing information about the battery cells during operation.

12. The battery pack assembly of claim 11, wherein the at least one sensor comprises at least one temperature sensor extending from a first surface of the supporting layer and coupled with the signal port via the printed circuit traces.

13. The battery pack assembly of claim 12, wherein the first surface of the supporting layer is disposed against an outer surface of one of the first and second cell carriers and the at least one temperature sensor extends through at least one sensor opening in the outer surface of the one of the first and second cell carriers and is positioned near at least one of the battery cells for measuring battery temperature thereof during use.

14. The battery pack assembly of claim 12, wherein the at least one sensor comprises at least one first contact for electrically contacting a first one of the plurality of cell terminals of the battery cells and at least one second contact for electrically contacting a second one of the plurality of cell terminals of the battery cells, the at least one first and second contacts being coupled to the signal port via the printed circuit traces.

15. The battery pack assembly of claim 14, wherein the at least one first contact and the at least one second contact are resilient members.

16. The battery pack assembly of claim 11, wherein the supporting layer of the at least one measurement board comprises one or more openings and is disposed against an outer surface of one of the first and second cell carriers and the outer surface of said one of the first and second cell carriers comprises one or more corresponding standoffs that cooperate with the one or more openings to hold the at least one measurement board in place with respect to the one of the first and second cell carriers.

17. The battery pack assembly of claim 11, further comprising a battery management system board in signal communication with the signal port of the at least one measurement board for coupling with an external battery management system.

18. The battery pack assembly of claim 17, wherein the battery management system board is disposed in a first plane adjacent to an end plate at one end of the plurality of battery cells and the at least one measurement board is disposed in a second plane adjacent to one of the first and second cell carriers.

19. The battery pack assembly of claim 1, further comprising:
an enclosure for enclosing the first and second cell carriers and the plurality of battery cells therebetween; and
first and second pack terminals being electrically coupled to at least one first and at least one second cell terminals via first and second output bus bars, respectively, the first pack terminal and the second pack terminal providing contacts for coupling to an external electrical device.

20. The battery pack assembly of claim 1, further comprising an enclosure having enclosure walls for enclosing the first and second cell carrier and the plurality of battery cells therebetween, wherein at least one of the enclosure walls comprises at least one connecting groove for receiving a portion of at least one pack connector to couple the battery pack assembly with another battery pack assembly, the at least one connecting groove having a shape corresponding to an end of the at least one pack connector, the shape being a top portion of an I-shape or a C-shape.

21. A battery pack system comprising:
at least one pack connector for coupling two battery pack assemblies together;
a first battery pack assembly including:
a first battery pack enclosure having a first enclosure wall with at least one connecting groove having a shape corresponding to a first end of the at least one pack connector; and
a first battery pack sub-assembly disposed within the first battery pack enclosure; and
a second battery pack assembly including:
a second battery pack enclosure having a second enclosure wall that is disposed adjacent to the first enclosure wall of the first battery pack assembly, the second enclosure having at least one connecting groove with a shape corresponding to a second end of the at least one pack connector; and
a second battery pack sub-assembly disposed within the second battery pack enclosure.

22. The battery pack system of claim 21, wherein each end of the at least one pack connector comprises a flange.

23. The battery pack system of claim 21, wherein the at least one pack connector has a cross-section comprising an I-shape or a C-shape.

24. A battery pack sub-assembly comprising:
a plurality of battery cells being arranged in a spaced apart fashion between first and second cell carriers; and
at least one measurement board comprising a supporting layer having printed circuit traces thereon, a signal port, and at least one sensor electrically coupled to the signal port via the printed circuit traces and extending from a first surface of the supporting layer towards at least one of the battery cells for measuring information therefrom during operation.

25. The battery pack assembly of claim 24, wherein the at least one sensor comprises at least one temperature sensor extending from the first surface of the supporting layer through one of the first and second cell carriers towards the at least one of the battery cells for measuring temperature thereof during use.

26. The battery pack assembly of claim 24, wherein the at least one sensor comprises at least one first contact for electrically contacting at least a first cell terminal from the plurality of battery cells and at least one second contact for electrically contacting at least a second cell terminal from the plurality of battery cells.

27. The battery pack assembly of claim 24, further comprising at least one battery management terminal in signal communication with the signal port of the at least one measurement board for electrical coupling with a battery management system board.

28. A method of manufacturing a battery pack sub-assembly, the method comprising:
positioning a first cell carrier adjacent to first ends of a plurality of battery cells;
positioning a second cell carrier adjacent to second ends of the plurality of battery cells;
retaining at least one of the first ends and the second ends of the plurality of battery cells within a matrix of recesses of at least one of the first cell carrier and the second cell carrier;
extending a plurality of cell terminals of the plurality of battery cells extend through terminal openings of at least one of the first cell carrier and the second cell carrier;
coupling a plurality of electrically conductive interconnecting elements to the plurality of cell terminals that extend through the terminal openings of the at least one of the first cell carrier and the second cell carrier according to a predetermined circuit configuration for the plurality of battery cells.

29. The method of claim 28, wherein at least one of the electrically conductive interconnecting elements comprises a bus bar that is laser welded to at least two cell terminals of the plurality of cell terminals.

30. The method of claim 28, further comprising retaining the first cell carrier, the second cell carrier and the plurality of battery cells in a fixed position using at least one strap extending thereabout.

31. The method of claim 28, further comprising positioning at least one measurement board having at least one sensor over an outer surface of one of the first cell carrier and the second cell carrier to extend the at least one sensor towards the at least one of the plurality of battery cells.

32. The method of claim 31, wherein the at least one sensor comprises at least one temperature sensor that extends from the at least one measurement board through at least one opening of the one of the first cell carrier and the second cell carrier to be positioned amidst the battery cells.

33. The method of claim 31, wherein the at least one sensor comprises at least first and second contacts and the method comprises positioning the at least one measurement board over an outer surface of one of the first cell carrier and the second cell carrier to electrically couple the at least one first contact with at least one of the plurality of electrically conductive interconnecting elements and the at least one second contact with at least one other of the plurality of electrically conductive interconnecting elements.
